(19) United States
(12) Patent Application Publication
(10) Pub. No.: US 2026/0319715 A1
(43) Pub. Date: Oct. 15, 2026

(54) PRINTER, MAINTENANCE SERVER, NON-TRANSITORY MEDIUM STORING PRINTER CONTROL PROGRAM, AND PRINTER SYSTEM

(71) Applicant: BROTHER KOGYO KABUSHIKI KAISHA, Nagoya (JP)

(72) Inventors: Maya TABUCHI, Nagoya (JP); Michihiko FURUHASHI, Ichinomiya (JP); Kiichi YOSHIDA, Nagoya (JP); Miyako KOZAWA, Nagoya (JP)

(21) Appl. No.: 19/464,120

(22) Filed: Jan. 29, 2026

(30) Foreign Application Priority Data
Jan. 31, 2025 (JP) 2025-015648

(51) Int. Cl. G06F 3/12

(52) U.S. Cl. CPC G06F 3/1204; G06F 3/121; G06F 3/1229; G06F 3/1231; G06F 3/125; G06F 3/1265; G06F 3/1288

(57) ABSTRACT

A printer includes a memory storing a maintenance address, which is the address of a maintenance server; a printing mechanism; a communication interface; and a processor. The processor performs a first transmitting process, a first receiving process, a second receiving process, a print instruction obtaining process, and a printing process. The first transmitting process is a process of transmitting printer-related information to the maintenance server. The first receiving process is a process of receiving a management address from the maintenance server. The second receiving process is a process of accessing a management server using the management address and receiving template data corresponding to the printer. The print instruction obtaining process is a process of obtaining a first print instruction or a second print instruction. The printing process is a process of causing the printing mechanism to print a print image based on the first or second print instruction.

### REFERENCE TO RELATED APPLICATIONS

This application claims priority from Japanese Patent Application No. 2025-015648 filed on Jan. 31, 2025. The entire content of the priority application is incorporated herein by reference.

### BACKGROUND ART

A known information processing system includes a device management application, a communication management apparatus, and managed devices, and is capable of automatically performing setup of the management devices according to a user using the office. Each of the managed devices transmits device identification information of the managed device to the communication management apparatus when the managed devices are installed. The communication management apparatus communicates bi-directionally with the device management application and each of the managed devices. The communication management apparatus verifies the device identification information of each of the managed devices, registered when each of the managed devices has been shipped, with the device identification information received from each of the managed devices. The communication management apparatus determines whether each of the managed devices is a managed device which can be registered, and notifies the result of the determination to the device management application. The device management application monitors and controls each of the managed devices via the communication management apparatus. The device management application displays managed device or managed devices, of the managed devices, which can be registered, and registers all the managed devices at once. The device management application sets up an application and configuration information for each of the managed devices. In a case where the communication management apparatus sets up a managed device, of the managed devices, again, the communication management apparatus determines the application and the configuration information to be introduced in the managed device, based on user group identification information on a user group to which a user who uses the managed device belongs.

### SUMMARY

In a printing technique using template data for printing a predetermined print content based on a predetermined layout, a user, etc., desires, in some cases, to cause a printer to easily obtain template data which is to be used in the printer. The above-described known information processing system does not take into account the configuration to cause a printer to obtain template data to be used in the printer.

The present disclosure aims to provide a printer, maintenance server, a non-transitory medium storing a printer control program, and a printer system each of which is able to obtain template data to be used in the printer more easily than the known technique.

A printer according to a first aspect of the present disclosure includes: a memory configured to store a maintenance address which is an address of a maintenance server; a printing mechanism; a communication interface; and a processor. The processor is configured to perform: a first transmitting process, a first receiving process, a second receiving process, a print instruction obtaining process, and a printing process. The first transmitting process is a process of accessing the maintenance server using the maintenance address and of transmitting printer-related information related to the printer to the maintenance server via the communication interface. The first receiving process is a process of receiving, from the maintenance server via the communication interface and in accordance with the first transmitting process, a management address indicating a source from which template data is obtainable. The template data corresponds to the printer-related information and is usable for printing a predetermined print content based on a predetermined layout. The second receiving process is a process of accessing a management server using the management address and of receiving the template data corresponding to the printer via the communication interface. The management server is the same as or different from the maintenance server. The print instruction obtaining process is a process of obtaining a first print instruction or a second print instruction. The first print instruction includes a template ID for identifying the template data, and print content data-related information. The print content data-related information is related to print content data indicating the print content. The second print instruction includes image data indicating a print image based on the print content data and the template data. The printing process is a process of causing the printing mechanism to perform printing of a print image based on the first print instruction, or the print image indicated by the image data included in the second print instruction. The print image based on the first print instruction is an image in which the print content is applied to the layout indicated by the template data associated with the template ID.

The first receiving process and the second receiving process of the printer according to the first aspect contribute to facilitating the process of receiving the template data corresponding to the printer from the management server, as compared with the known technique. In a case where a template corresponding to each of a plurality of printers needs to be set with respect to each of the plurality of printers, an administrator managing the plurality of printers sets, in the maintenance server, the management address in which the template data to be obtained by each of the plurality of printers is stored. With this, each of the plurality of printers can obtain the management address by accessing the maintenance server, and thus can obtain the template data using the management address. Therefore, the first receiving process and the second receiving process of the printer contribute to setting the template to be used for printing more easily than the known technique.

A maintenance server according to a second aspect of the present disclosure includes: a maintenance server memory; a maintenance server communication interface configured such that a printer accesses the maintenance server communication interface using a maintenance address; and a maintenance server processor. The maintenance server processor is configured to perform: an address storing process; a related information receiving process; and a management address transmitting process. The address storing process is a process of storing printer-related information related to the printer and a management address indicating a source from which template data is obtainable in the maintenance server memory, while associating the management address and the printer-related information with each other. The management address is an address of a management server which is a server same as or different from the maintenance server. The template data is usable for printing a predetermined print content based on a predetermined layout. The related information receiving process is a process of receiving, via the maintenance server communication interface, the printer-related information from the printer which has accessed the maintenance server using the maintenance address. The management address transmitting process is a process of transmitting the management address, which corresponds to the printer-related information and is stored in the maintenance server memory, to the printer via the maintenance server communication interface, in response to the maintenance server processor receiving the printer-related information.

The address storing process and the management address transmitting process of the maintenance server according to the second aspect contribute to enabling the administrator of the plurality of printers to register the management addresses, each corresponding to one of the plurality of printers, collectively with the maintenance server. The maintenance server contributes to saving the user time and effort in setting the management address necessary for accessing the management server in each of the plurality of printers.

A non-transitory medium according to a third aspect of the present disclosure stores a printer control program for controlling a printer. The printer includes: a memory configured to store a maintenance address which is an address of a maintenance server; a printing mechanism; a communication interface; and a processor. The printer control program causes the processor to perform: a first transmitting process; a first receiving process; a second receiving process; a print instruction obtaining process; and a printing process. The first transmitting process is a process of accessing the maintenance server using the maintenance address and of transmitting, via the communication interface, printer-related information related to the printer to the maintenance server. The first receiving process is a process of receiving, from the maintenance server via the communication interface and in accordance with the first transmitting process, a management address indicating a source from which template data is obtainable. The template data corresponds to the printer-related information and is usable for printing a predetermined print content based on a predetermined layout. The second receiving process is a process of accessing a management server using the management address, the management server being the same as or different from the maintenance server, and of receiving the template data corresponding to the printer via the communication interface. The print instruction obtaining process is a process of obtaining a first print instruction or a second print instruction. The first print instruction includes a template ID for identifying the template data, and print content data-related information. The print content data-related information is related to print content data indicating the print content. The second print instruction includes image data indicating a print image based on the print content data and the template data. The printing process is a process of causing the printing mechanism to perform printing of a print image based on the first print instruction, or the print image indicated by the image data included in the second print instruction. The print image based on the first print instruction is an image in which the print content is applied to the layout indicated by the template data associated with the template ID. The printer control program stored in the non-transitory medium according to the third aspect is performed by the processor of the printer to thereby achieve an effect similar to the effect achieved by the printer according to the first aspect.

A printer system according to a fourth aspect of the present disclosure includes: a printer; a maintenance server; and a management server. The printer includes: a memory configured to store a maintenance address which is an address of the maintenance server; a printing mechanism; a communication interface; and a processor. The processor is configured to perform: a first transmitting process; a first receiving process; a second receiving process; a print instruction obtaining process; and a printing process. The first transmitting process is a process of accessing the maintenance server using the maintenance address and of transmitting, via the communication interface, printer-related information related to the printer to the maintenance server. The first receiving process is a process of receiving, from the maintenance server via the communication interface and in accordance with the first transmitting process, a management address indicating a source from which template data is obtainable. The template data corresponds to the printer-related information and is usable for printing a predetermined print content based on a predetermined layout. The second receiving process is a process of accessing a management server using the management address, the management server being the same as or different from the maintenance server, and of receiving the template data corresponding to the printer via the communication interface. The print instruction obtaining process is a process of obtaining a first print instruction or a second print instruction. The first print instruction includes a template ID for identifying the template data, and print content data-related information. The print content data-related information is related to print content data indicating the print content. The second print instruction includes image data indicating a print image based on the print content data and the template data. The printing process is a process of causing the printing mechanism to perform printing of a print image based on the first print instruction, or the print image indicated by the image data included in the second print instruction. The print image based on the first print instruction is an image in which the print content is applied to the layout indicated by the template data associated with the template ID.

The maintenance server includes: a maintenance server memory; a maintenance server communication interface configured such that the printer accesses the maintenance server using the maintenance address; and a maintenance server processor. The maintenance server processor is configured to perform: an address storing process; a related information receiving process; and a management address transmitting process. The address storing process is a process of storing the printer-related information related to the printer and the management address indicating a source from which the template data is obtainable, in the maintenance server memory, while associating the management address with the printer-related information. The management address is an address of the management server. The related information receiving process is a process of receiving, via the maintenance server communication interface, the printer-related information from the printer which has accessed the maintenance server using the maintenance address. The management address transmitting process is a process of transmitting the management address corresponding to the printer-related information and stored in the maintenance server memory, to the printer via the maintenance server communication interface, in response to the maintenance server processor receiving the printer-related information.

The management server includes: a management server memory; a management server communication interface configured such that the printer accesses the management server using the management address; and a management server processor. The management server processor is configured to perform: a template storing process, and a template transmitting process. The template storing process is a process of storing the template data corresponding to the printer for the management addresses in the management server memory. The template transmitting process is a process of transmitting the template data corresponding to the printer and stored in the management server memory, to the printer via the management communication interface, in response to the printer accessing the management server using the management address.

The first receiving process and the second receiving process of the printer of the printer system according to the fourth aspect contribute to facilitating the process of receiving the template data corresponding to the printer from the management server, as compared with the known technique. In a case where a template corresponding each of a plurality of printers needs to be set with respect to each of the plurality of printers, an administrator managing the plurality of printers sets, in the maintenance server, the management address in which the template data to be obtained by each of the plurality of printers is stored. With this, each of the plurality of printers can obtain the management address by accessing the maintenance server, and thus can obtain the template data using the management address. Therefore, the first receiving process and the second receiving process of the printer contribute to setting the template to be used for printing more easily than the known technique.

The address storing process and the management address transmitting process of the maintenance server of the printer system according to the fourth aspect contribute to enabling the administrator of the plurality of printers to register the management addresses each corresponding to one of the plurality of printers collectively with the maintenance server. The maintenance server contributes to saving the user the time and effort of setting the management addresses necessary for accessing the management server in each of the plurality of printers. The template transmitting process of the maintenance server of the printer system according to the fourth aspect contributes to facilitating the process of transmitting, to a certain printer which is included in the plurality of printers and which has accessed the management server using the management address, the template data corresponding to the certain printer, as compared with the known technique.

### BRIEF DESCRIPTION OF DRAWINGS

FIG. 1 is a block diagram of a printer system including a plurality of printers, a management server, and a maintenance server.

FIG. 2A is a view illustrating a print image based on template data, FIG. 2B is a view illustrating a print content data list, and FIG. 2C is a view illustrating a print image in which a print content indicated by print content data in the print content data list is disposed in a predetermined layout.

FIG. 3A is a view illustrating data transmitted and received between a printer A belonging to segment X under a condition that a next connection address is a maintenance address, the maintenance server, and the management server; and FIG. 3B is a view illustrating data transmitted and received between the printer A belonging to the segment X under a condition that the next connection address is a management address, and the management server.

FIG. 4A is a view illustrating data transmitted and received between a printer B, which belongs to segment X under the condition that the next connection address is the maintenance address, the maintenance server, and the management server; and FIG. 4B is a view illustrating data transmitted and received between a printer C which belongs to the segment X under the condition that the next connection address is the maintenance address, and the management server.

FIGS. 5A and 5B are a flowchart of a printer process.

FIG. 6 is a timing chart corresponding to a case where the printer A in Specific Example 1 performs the printer process in a first mode.

FIGS. 7A and 7B are a flowchart of the printer process performed in a second mode.

FIG. 8 is a timing chart corresponding to a case where the printer A in Specific Example 2 performs the printer process in the second mode.

FIG. 9 is a flowchart of a substitute printer process performed in the printer process.

FIG. 10 is a timing chart corresponding to a case where the printer B in Specific Example 3 performs the printer process in the first mode.

FIG. 11 is a flowchart of a print controlling process.

FIG. 12 is a flowchart of a maintenance server process.

FIGS. 13A and 13B are views illustrating the transitions of a table 100 stored in a memory of the maintenance server.

FIGS. 14A and 14B are a flowchart of a management server process.

FIG. 15 is a flowchart of an obtainment requesting process performed in the management server process.

FIGS. 16A to 16C are views illustrating the transition of tables.

FIGS. 17A and 17B are a flowchart of a registration requesting process performed in the management server process.

FIGS. 18A and 18B are each a view illustrating a table.

FIGS. 19A to 19C are views illustrating the transition of the print content data list.

FIG. 20 is a flowchart of an image data transmitting process performed in the management server process.

FIG. 21 is a view illustrating a table stored in a memory of the maintenance server in the first modification.

FIG. 22 is a view illustrating a table stored in a memory of the maintenance server of the second modification.

### DESCRIPTION

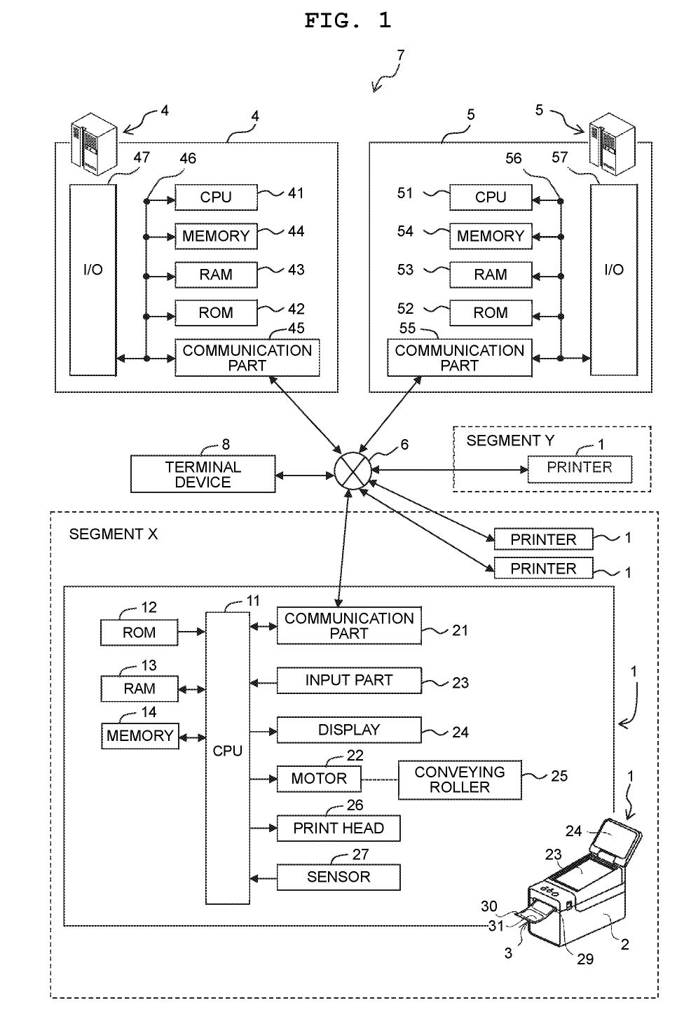

An embodiment of the present disclosure will be described with reference to the drawings. As illustrated in FIG. 1, a printer system 7 includes a plurality of printers 1, a management server 4, and a maintenance server 5. The printer system 7 is hereinafter referred to as a "system 7". As a specific example of the present disclosure, a case will be described in which the system 7 is used as a system configured to manage a plurality of printers 1 each of which is used in a corresponding one of a plurality of sushi stores owned by a sushi sales company.

Each of the plurality of printers 1 is a thermal printer configured to be capable of printing a print image representing a print content on a print medium 3. The plurality of printers 1 has a configuration which is the same as or similar to each other. The term "configuration which is the same as or similar to each other" means that the printers are configured to print a print image representing a print content on a print medium 3 of the same standard. The plurality of printers 1 may differ from each other in terms of the manufacturing model, model number, etc.

The print medium 3 is not limited to a specific medium. The print medium 3 is, for example, a medium having a sheet shape or a medium having a roll shape. The print medium 3 in the present embodiment is, as an example, a plurality of labels 31 continuously affixed to a long backing paper sheet 30. The print content is an object (to be) printed on the print medium 3. The print content is, for example, a letter, a symbol, a number, a figure, and a pictogram. The print content is indicated by print content data.

A print image is an image to be printed by a print head 26 and is a single image to be printed on a single print unit. The print unit is set appropriately in accordance with the kind of the print medium 3. The print unit in the present embodiment is a label, and the print image is a single image to be printed on a single label. The print image is indicated by a plurality of pixels which divide the print image into a plurality of regions. The print image in the present embodiment indicates one or more print contents composed of white pixels and black pixels.

The label 31 on which the print image is printed is affixed to various objects, for example, a name tag, a file spine, a product tag or a price tag in a store, a postal envelope, an industrial material, a supply, an organizer, and a sign. The label 31 of the present embodiment is affixed to a product package. Therefore, if such a case where the printer 1 is temporarily out of service for a period of time due to, for example, a malfunction, occurs, such a case is not desirable since the label 31 cannot be affixed to the product package. For this reason, each of the sushi stores includes the plurality of printers 1. The management server 4 registers a predetermined printer 1, among the plurality of printers 1, in each of the sushi stores as a managed printer to be managed by the management server 4. The user of the printer 1 in each of the sushi stores uses the managed printer of the plurality of printers 1, in each of the sushi stores during normal operation.

The user registers a substitute printer with the maintenance server 5, while associating the substitute printer with the managed printer. The substitute printer is another printer 1, included in the plurality of printers 1 and different from the managed printer. The substitute printer is used as a substitute for the managed printer. The user keeps the substitute printer unused as long as the managed printer is usable (operational), since even in a case the user wishes to use the substitute printer 1 as well as the managed printer 1, the space in which the printers 1 can be placed is not sufficient, in some cases. Note, however, that such a case is also presumed where the user prepares the substitute printer so as to reduce the downtime in such a situation where the managed printer cannot perform printing promptly due to, for example, a malfunction. In a case where the user cannot use the managed printer due to, for example, the malfunction, etc., the user uses the substitute printer.

The plurality of printers 1 in the present embodiment are managed in units of stores in the printer system 7. The unit for managing the plurality of printers 1 is referred to as a "segment". The segment represents the affiliation of the printers. FIG. 1 illustrates three printers 1 belonging to a segment X and one printer 1 belonging to a segment Y.

Each of the plurality of printers 1 has a case 2, an input part 23, a display 24, a motor 22, a conveying roller 25, and a print head 26. The case 2 accommodates a roll around which the print medium 3 is wound. A rectangular-shaped discharge port 29 is defined in the case 2.

The input part 23 is a user interface which accepts an operation by the user. The input part 23 in the present embodiment is a touch screen which detects a location pressed by the user. The display 24 is a liquid crystal display (LCD) disposed in the surface of the case 2.

The motor 22 rotates the conveying roller 25 configured to convey the print medium 3. The motor 22 in the present embodiment is a stepping motor. The conveying roller 25 is supported by the case 2 to be rotatable about a rotation axis extending parallel to the longitudinal direction of the discharge port 29. The conveyance roller 25 rotates in accordance with the drive of the motor 22 so as to convey the print medium 3, which is accommodated inside the case 2, to the discharge port 29.

The print head 26 is configured to be capable of printing a print image on the print medium 3. The print head 26 is, for example, a line head, and is accommodated inside the case 2. The print head 26 has a plurality of heating elements, and prints a print image on the print medium 3 by selectively heating the plurality of heating elements.

The printer 1 has a CPU 11, a ROM 12, a RAM 13, and a memory 14. The CPU 11 has overall control of the printer 1. The CPU 11 is electrically connected to the ROM 12, RAM 13, the memory 14, a communication part 21, the input part 23, the display 24, the motor 22, the print head 26, and a sensor 27.

The ROM 12 stores various programs, etc. The RAM 13 stores various parameters necessary for executing the programs. The memory 14 is nonvolatile. The memory 14 stores various data and programs, etc., to perform a process to be described later.

The memory 14 stores a next connection address. The next connection address indicates an address of a server which is either the management server 4 or the maintenance server 5, and which the printer 1 is to access next time. The initial value of the next connection address is a maintenance address which is an address of the maintenance server 5. The address may be any information which uniquely identifies the server on the network 6. The address is indicated, for example, by a URL (Uniform Resource Locator), an IP address, or a MAC address.

In a case where the CPU 11 receives the address of the management server 4 from the maintenance server 5, in response to the printer 1 accessing the maintenance address, the CPU 11 stores the management address in the memory 14. The management address indicates a storage location in which template data is stored. The template data is to be used in a case where the printer 1 is used as a managed printer or a substitute printer.

In a case where the management address is stored in the memory 14, the CPU 11 sets the next connection address to the management address. In a case where the management address is not stored in the memory 14, the CPU 11 sets the next connection address to the maintenance address. By setting the initial value of the next connection address to the maintenance address, the memory 14 contributes to saving the time and effort of individually setting the management address for each of the printers 1.

The communication part 21 is an interface configured to connect the printer 1 to the network 6. The CPU 11 is capable of performing data transmission and reception with other devices connected to the network 6, such as the management server 4, the maintenance server 5, and a terminal device 8, via the communication part 21. The terminal device 8 is a device used by the owner, the administrator, or the user of the printer 1. The terminal device 8 is, for example, a smartphone, a PC, etc. The communication system of the communication part 21 may be wireless communication or wired communication. The communication system in the wireless communication may include, for example, wireless LAN and Bluetooth (a registered trademark of Bluetooth SIG Inc.). The communication system in the wired communication may include, for example, USB (Universal Serial Bus) and wired LAN.

The sensor 27 is configured to detect an error occurring in the printer 1. The kind of the sensor, the manner the sensor 27 is disposed, and the number of the sensor 27 may be selected in accordance with the error which is to be detected. The error occurring in the printer 1 includes, for example, abnormality in the placement of the print medium 3, jamming of the print medium 3, shortage of the print medium 3, abnormal temperature of the print head 26, malfunction of the motor 22, and malfunction of the sensor 27.

For example, the abnormality in the placement of the print medium 3, the jamming of the print medium 3, and the shortage of the print medium 3 are detected by an optical sensor. The abnormal temperature of the print head 26 is detected by a temperature sensor. The malfunction of the motor 22 is detected by an encoder, which detects the rotational velocity and the position of the motor 22, or a temperature sensor. The malfunction of the sensor 27 is detected by the sensor 27 during calibration of the sensor 27.

The management server 4 manages the template data which is used by each of a plurality of managed printers. Each of the plurality of managed printers is a printer 1 registered with the management server 4 as the managed printer. The management server 4 in the present embodiment also manages a print content data list corresponding to the template data, and the print history of each of the managed printers.

The management server 4 has a CPU 41, a ROM 42, a RAM 43, a memory 44, a communication part 45, and an input/output (I/O) interface 47. The CPU 41 is electrically connected to the ROM 42, the RAM 43, the memory 44, the communication part 45, and the I/O interface 47, via bus 46.

The CPU 41 controls the management server 4. The ROM 42 stores a boot program, BIOS, etc. The CPU 41 causes the RAM 43 to store temporary data. The memory 44 is a nonvolatile storage device. The memory 44 stores various data and a program, etc., so as to perform a process to be described later.

The communication part 45 is an interface configured to connect the management server 4 to the network 6. The CPU 41 is capable of performing data transmission and reception with other devices connected to the network 6, such as the printer 1 or the terminal device 8, via the communication part 45. The communication system of the communication part 45 may be wireless or wired communication.

The maintenance server 5 manages the management address, which is the address of the management server 4, with respect to each of the plurality of managed printers. The management address indicates the storage location of the template data. The maintenance server 5 in the present embodiment also manages the correspondence between the managed printer and a substitute printer used as a substitute for the managed printer.

The maintenance server 5 has a CPU 51, a ROM 52, a RAM 53, a memory 54, a communication part 55, and an input/output (I/O) interface 57. The CPU 51 is electrically connected to the ROM 52, the RAM 53, the memory 54, the communication part 55, and the I/O interface 57, via a bus 56.

The CPU 51 controls the maintenance server 5. The ROM 52 stores a boot program, BIOS, etc. The CPU 51 causes the RAM 53 to store temporary data. The memory 54 is a nonvolatile storage device. The memory 54 stores various data and a program, etc., so as to perform a process to be described later.

The communication part 55 is an interface configured to connect the maintenance server 5 to the network 6. The CPU 51 is capable of performing data transmission and reception with other devices connected to the network 6, such as the printer 1 or the terminal device 8, via the communication part 55. The communication system of communication part 55 may be wireless or wired communication.

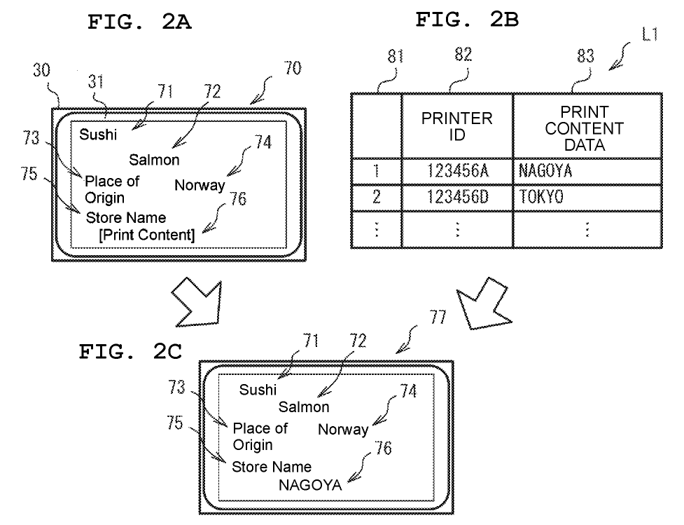

The template data and the print content data list L1 stored by the memory 44 of the management server 4 will be described, with reference to FIGS. 2A to 2C. FIG. 2A illustrates an example of a print image 70 indicated by the template data. The template data is data for printing a print content based on a predetermined layout. The template data is data which defines the layout, in the print image, of one or more print contents included in the print image. The template data in the present embodiment is data for printing a print image on a label 31 to be affixed to a product package. The product package is commonly used in each of the plurality of sushi stores owned by the sushi sales company.

The layout defines as to how one or more print contents are disposed on the print image. The layout includes, for example, the position(s) of the print content(s), the size(s) of the print content(s), the spacing between a plurality of print content(s), the alignment method of the print contents, the layer(s) of the print content(s), and the orientation of the print content(s). The alignment method of the print contents is the manner in which the print contents are aligned, for example, including left-aligned, right-aligned, left-right centered, top-aligned, bottom-aligned, and top-bottom centered. The left-right and direction and the top-bottom direction, as the basis for the alignment of the print contents, are set appropriately based on the longitudinal and short directions of the print medium 3. The direction of the print content(s) defines the orientation of the print content(s), i.e., the angle of rotation, of the print content(s), relative to the reference.

The print content in the present embodiment includes a fixed print content and an inserted print content. The fixed print content is a print content which is common regardless of the printers 1. The fixed print content is disposed in the layout defined by the template data. The data indicating the fixed print content in the present embodiment is included in the template data.

The inserted print content is a print content indicated by print content data associated with identification information. The inserted print content is disposed in a predetermined layout. The identification information is information for identifying the print content data. The identification information in the present embodiment is printer-related information related to the printer 1. The printer-related information associated with the print content data in the present embodiment is a first printer ID for identifying the printer 1. The identification information may be a print content data ID for identifying the print content data.

The printer-related information in the present embodiment is also used to determine whether the printer 1 is a printer 1 registered with the printer system 7. The printer-related information may be information with which a printer 1 registered with the printer system 7 can be distinguished from a printer 1 not registered with the printer system 7. The printer-related information may include mutually same information or mutually different information, depending on data associated with the printer-related information and a process performed with respect to the printer-related information.

In a case where the printer system 7 manages the printers 1 in units of the printer 1, the printer-related information may be a printer ID for identifying the printer 1. In a case where the printer system 7 manages the printers 1 in units of the segments to which each of the printers 1 belongs, the printer-related information may be a segment ID for identifying the segment. The printer-related information may be a user ID for identifying the owner, the administrator, or the user of the printer 1.

The predefined layout is a layout defined by the template data. The data indicating the inserted print content is not included in the template data; rather, the data indicating the inserted print content is obtained from the print content data list corresponding to the template data. The template data includes a so-called script. The script is an instruction for reading the inserted print content, associated with the printer-related information, from the print content data list, and for inserting the inserted print content into the layout.

In a specific example illustrated in FIG. 2A, the print image 70 includes fixed print content 71 to 75 and an inserted print content 76. The fixed print content 71 indicates a character string "Sushi". The fixed print content 72 indicates a character string "Salmon". The fixed print content 73 indicates a character string "Place of Origin". The fixed print content 74 indicates a character string "Norway". The fixed print content 75 indicates a character string "Store Name". The inserted print content 76 is indicated by "[print content]". As illustrated in FIG. 2A, the template data in the specific example defines the positions, the sizes, the alignment method, the layers, and the orientations of the plurality of print contents indicated by the print image 70.

FIG. 2B illustrates an example of the print content data list L1. The print content data list L1 stores a data number 81, a printer ID 82, and print content data 83 for each of the plurality of managed printers, in association with one another. The print content data 83 indicates the print content. The managed printers are printers of which printer IDs are registered with the management server 4.

In the present specification, the phrase "store first data and second data in association with each other" and "store first data and second data while associating the first data and the second data with each other" means storing related information related to the first data and related information related to the second data, in addition to storing the first data and the second data. By storing the first data and the second data in association with each other, the processor can obtain, based on the first data, the second data associated with the first data. The phrase "the second data associated with the first data" means the second data in which the related information, of the second data, related to the first data is stored.

The print content data list L1 is stored in the memory 44 of the management server 4 while being associated with predetermined template data. The predetermined template data defines a layout of the print content indicated by the print content data stored in the print content data list L1.

The printer ID 82 stored in the print content data list L1 in the present embodiment may be information with which a certain printer 1 can be distinguished from another printer 1 in the printer system 7. The printer ID 82 may be a serial number or an address assigned to the printer 1 such as an IP address and a MAC address. The printer ID 82 may be a value assigned in the printer system 7. The printer ID 82 in the present embodiment as illustrated in FIG. 2B is a character string in which six digits and a single alphabetical character are combined.

A print content indicated by the print content data 83 stored in the print content data list L1 is inserted into the inserted print content 76 in the present embodiment. The print content indicated by the print content data 83 is a string of characters in Romanized form of the store name. In a case where the printer ID is "123456A", a print content "NAGOYA" is disposed in the inserted print content 76, as indicated in a print image 77 illustrated in FIG. 2C. The print content "NAGOYA" is indicated by the print content data associated with the printer ID "123456A" included in the print content data list L1.

A process performed in the system 7 in the present embodiment will be described. The four printers illustrated in FIG. 1 are defined as "printers A to D", as follows. The printers A to C are used in a sushi store of which segment ID is "X" and of which store name is "NAGOYA". The printer D is used in a sushi store of which segment ID is "Y" and of which store name is "TOKYO".

The printers A and D are managed printers of which printer IDs are registered with the management server 4. The printer A receives the template data, and the print content data list L1 corresponding to the template data from the management server 4 via the communication part 21. The printer A performs printing of the print image 77 using the template data, and the print content data list L1 corresponding to the template data.

The printer B is a printer of which printer ID is not registered with the management server 4. The printer B is a substitute printer which performs printing of the print image 77 as a substitute for the printer A in a case where the printer A is unable to perform printing of the print image 77 due to, for example, a malfunction. The printer B is registered with maintenance server 5 as a substitute printer for the printer A.

The printer C is a printer of which printer ID is not registered with the management server 4. The printer C is not registered with the maintenance server 5 as a substitute printer for the printer A. The printer C is used for normal printing which does not use the template data managed by the management server 4.

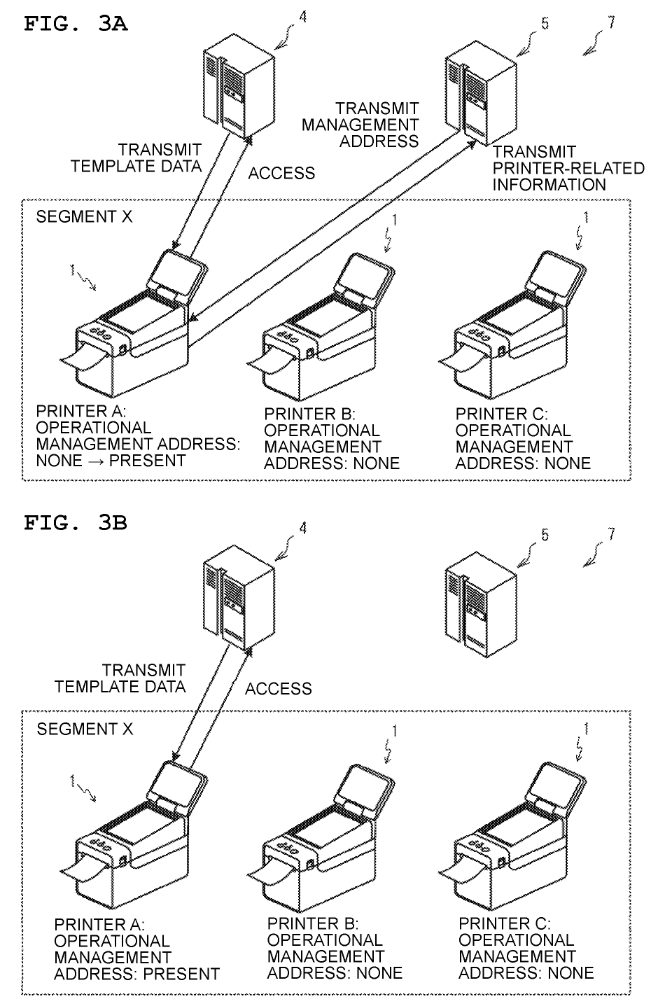

A process performed in Specific Example 1, in which the printer A performs printing under a condition that the next connection address is the maintenance address, will be described with reference to FIG. 3A. In a case where the printer A in Specific Example 1 performs printing by obtaining the template data corresponding to the printer A from the management server 4, the system 7 performs the following process.

The CPU 11 of the printer A accesses the maintenance server 5 using the maintenance address, and transmits the printer-related information related to the printer A to the maintenance server 5 via the communication part 21.

The memory 54 of the maintenance server 5 stores the management address and the printer-related information in association with each other. The management address is the address of the management server 4 and indicates a source from which the template data is obtainable. The template data corresponds to the printer-related information. The template data is data for performing printing of a predetermined print content based on a predetermined layout.

The CPU 51 of the maintenance server 5 receives the printer-related information from the printer A, via the communication part 55. The CPU 51 transmits, to the printer A, a management address corresponding to the printer-related information related to the printer A via the communication part 55.

The CPU 11 of the printer A receives the management address from the maintenance server 5 via the communication part 21. The CPU 11 accesses the management server 4 using the management address. The management server 4 is a server which is the same as or different from the maintenance server 5.

The memory 44 of the management server 4 stores template data corresponding to the printer 1 for each of a plurality of management addresses. The CPU 41 performs the following process, in response to the printer A accessing the management server 4 using the management address. That is, the CPU 41 transmits predetermined template data to the printer A via the communication part 45. The predetermined template data is template data corresponding to the printer A, among multiple template data stored in the memory 44.

The CPU 11 of the printer A receives the template data corresponding to the printer A via the communication part 21. The CPU 11 obtains a first print instruction or a second print instruction. The first print instruction includes a template ID, and print content data-related information which is related to the print content data. The template ID is data for identifying the template data. The print content data-related information is information for identifying print content data to which the layout indicated by the template data is applied.

The print content data-related information may be the print content data per se. The print content data-related information may be a print content data list which includes the print content data. The print content data-related information may be a list ID for identifying the print content data list.

The second print instruction includes image data indicating a print image based on the print content data and template data. The CPU 11 causes the print head 26 to print the print image.

The print image corresponding to a case where the CPU 11 obtains the first print instruction is an image in which the print content identified based on the first print instruction is applied to the predetermined layout. The predetermined layout is a layout indicated by the template data associated with the template ID. The print image corresponding to a case where the CPU 11 obtains the second print instruction is an image indicated by the image data based on the second print instruction.

A process performed in Specific Example 2, in which the printer A performs printing under a condition that the next connection address is the management address, will be described with reference to FIG. 3B. In a case where the printer A in Specific Example 2 performs printing by obtaining the template data corresponding to the printer A from the maintenance server 4, the system 7 performs the following process. The CPU 11 accesses the management server 4 using the management address stored in the memory 14 of the printer A and performs a process between the management server 4 and the printer A. Namely, the process between the maintenance server 5 and the printer A is omitted.

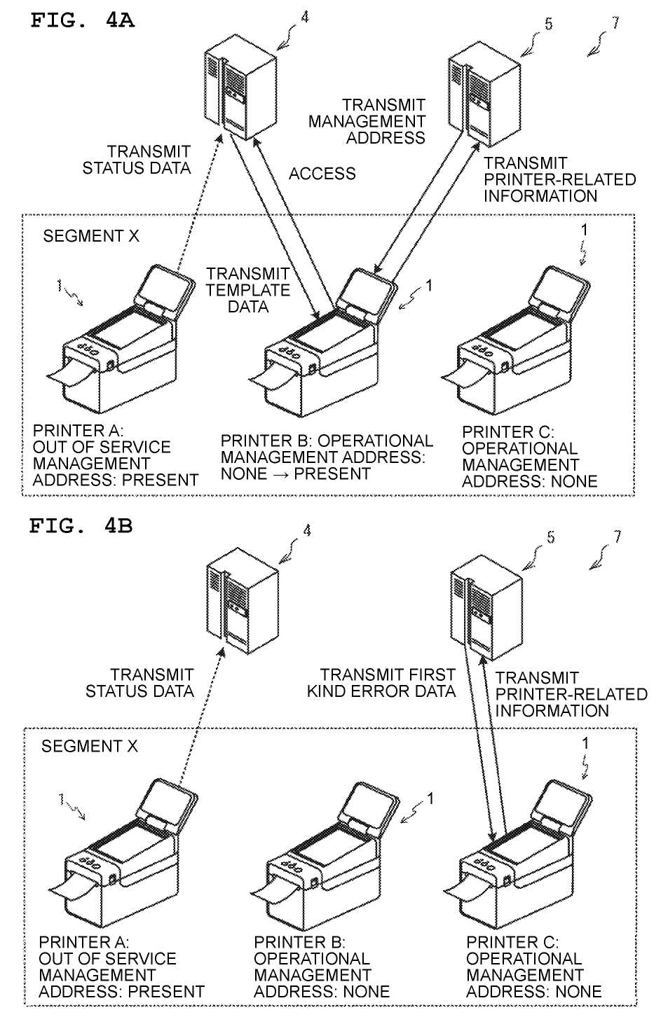

A process performed in Specific Example 3, in which the printer B performs printing under a condition that the next connection address is the maintenance address, will be described with reference to FIG. 4A. In a case where the printer B in Specific Example 3 performs printing by obtaining the template data corresponding to the printer A from the management server 4, as a substitute printer for the printer A which is out of service. In this case, the system 7 performs the following process.

The CPU 11 of the printer A transmits status data indicating that the printer A is out of service to the management server 4. The CPU 11 of the printer B accesses the maintenance server 5 using the maintenance address and transmits the printer-related information related to the printer B to the maintenance server 5 via the communication part 21. The CPU 51 of the maintenance server 5 transmits, to the printer B, a management address corresponding to the printer-related information related to the printer B, from among the plurality of management addresses, via the communication part 55.

The CPU 11 of the printer B receives the management address from the maintenance server 5 via the communication part 21. The CPU 11 accesses the management server 4 using the management address.

The CPU 41 of the management server 4 performs the following process, in response to the printer B accessing the management server 4. That is, the CPU 41 transmits predetermined template data to the printer B via the communication part 45. The predetermined template data is template data corresponding to the printer A, among the plurality of template data stored in the memory 44.

The CPU 11 of the printer B receives the template data corresponding to the printer A via the communication part 21. The CPU 11 obtains the first print instruction or the second print instruction. The CPU 11 causes the print head 26 to perform printing of the print image.

A process which is performed in Specific Example 4, and in which the printer C performs printing under a condition that the next connection address is the maintenance address, will be described, with reference to FIG. 4B. The printer C in Specific Example 4 performs printing while the printer A is out of service. In this case, the system 7 performs the following process.

The CPU 11 of the printer A transmits the status data indicating that the printer A is out of service to the management server 4. The CPU 11 of the printer C accesses the maintenance server 5 using the maintenance address and transmits printer-related information related to the printer C to the maintenance server 5 via the communication part 21.

The printer-related information of the printer C is not stored in the memory 54. The CPU 51 of the maintenance server 5 transmits first kind error data to the printer C via the communication part 55. The first-kind error data indicates that the printer 1 accessing the maintenance server 5 has not been registered previously with the maintenance server 5. The printer C performs normal printing without using the template data.

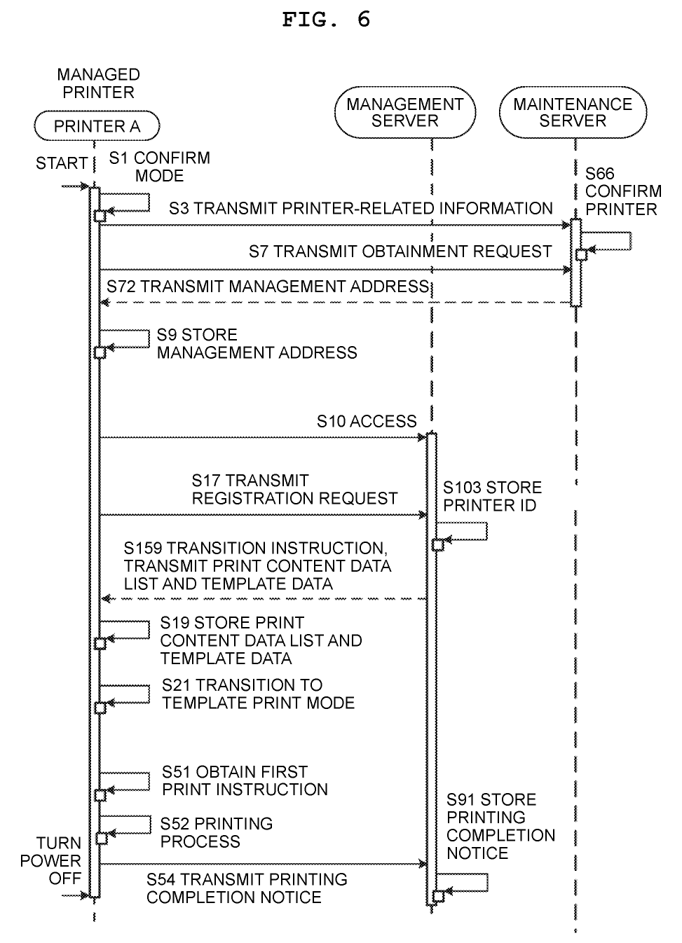

A printer process performed by the printer 1 will be described, using Specific Examples 1 to 4 and with reference to FIGS. 3A and 3B, 4A and 4B, 5A and 5B, and 6. The CPU 11 reads a program for performing the printer process from the memory 14 to the RAM 13, in a case where the power of the printer 1 is turned on. The program includes an instruction for causing the CPU 11 to perform the following process. The CPU 11 performs the following steps in accordance with the instruction included in the program read into the RAM 13.

In the following description, the printer ID of the printer 1 performing the process is also referred to as a "first printer ID". The printer ID of a managed printer which is different from the printer 1 performing the process and which is managed by the management server 4 is also referred to as a "second printer ID".

First, a case where the printer A in Specific Example 1 performs the printer process in a first mode will be described, with reference to FIGS. 3A, 5A and 5B, and 6. The CPU 11 of the printer A refers to the memory 14 and determines whether the printer process is to be performed in the first mode (step S1). In a case where the management address is not stored in the memory 14, the server to which the printer A is to connect next is the maintenance server 5, and the CPU 11 of the printer A performs the printer process in the first mode. In a case where the management address is stored in the memory 14, the server to which the printer A is to connect next is the maintenance server 4, and the CPU 11 of the printer A performs the printer process in the second mode.

In a case where the CPU 11 of the printer A in Specific Example 1 determines that the server to which the printer A is to connect next is the maintenance server 5 and that the printer process is to be performed in the first mode (step S1: YES), the CPU 11 performs an outputting process of outputting the first printer ID for identifying the printer A (step S2).

In the outputting process (step S2), the CPU 11 of the printer A causes the print head 26 to print a two-dimensional code on a print medium 3. The two-dimensional code indicates the first printer ID. The first printer ID indicated by the two-dimensional code is used in a process of registering the printer A with the maintenance server 5. The two-dimensional code may be selected from, for example, QR code (a registered trademark of DENSO WAVE INCORPORATED), VeriCode, CP code, AztecCode, and PDF417, etc., as appropriate. The two-dimensional code in the present embodiment is the QR code. In a case where the printer A is already registered with the maintenance server 5, the process of step S2 may be omitted.

The user of the printer A captures an image of the two-dimensional code printed on the print medium 3 with a camera of the terminal device 8, such as a smartphone. The terminal device 8 detects the two-dimensional code using pattern detection of identical cut-out symbols located in three corners among the four corners of the QR Code (registered trademark) in the captured image. The terminal device 8 accesses the maintenance server 5 using the printer-related information indicated by the two-dimensional code. The user operates the terminal device 8 to register the printer A with the maintenance server 5.

The process of step S2 may be omitted, or may be performed only in a case where the user instructs the CPU 11 to perform the printing of the two-dimensional code. The user of the printer A may register the printer A with the maintenance server 5 using the first printer ID displayed on the display 24. The user of the printer A may register the printer A with the maintenance server 5 using the first printer ID affixed to the printer A.

The CPU 11 accesses the maintenance server 5 using the maintenance address stored as the next connection address. The CPU 11 transmits the printer-related information related to the printer A to the maintenance server 5 via the communication part 21 (step S3). In step S3, a process of establishing a communication connection between the maintenance server 5 and the printer A, such as handshaking, is performed.

The maintenance server 5 uses the printer-related information to determine whether the printer A accessing the maintenance server 5 has been previously registered with the maintenance server 5. In a case where the printer 1 accessing the maintenance server 5 has not been previously registered with the maintenance server 5, the maintenance server 5 transmits the first kind error data to the printer 1. In a case where the printer 1 which has accessed the maintenance server 5 has been previously registered with the maintenance server 5, but the printer 1 fails to access the maintenance server 5, the maintenance server 5 transmits the second kind error data to the printer 1. The CPU 11 determines that the access to the maintenance server 7 has failed in a case where the CPU 11 receives the first kind error data or the second kind error data from the maintenance server 5 via the communication part 21.

In a case where the access to the maintenance server 5 has failed (step S3: NO), the CPU 11 determines whether the CPU 11 has received the first kind error data from the maintenance server 5 via the communication part 21 (step S4). In a case where the CPU 11 determines that the CPU 11 receives the first kind error data (step S4: YES), the CPU 11 causes the display 24 to display a predetermined message (step S5). The first kind error data indicates that the printer 1 is not registered with the maintenance server 5. The predetermined message is a message urging the user of the printer 1 to register the printer 1 with the maintenance server 5.

In a case where the CPU 11 determines that the CPU 11 has not received the first kind error data (step S4: NO), or after the process of step S5, the CPU 11 determines whether the number of retries is equal to or less than a threshold value (step S6). The case where the CPU 11 has not received the first kind error data is a case where the CPU 11 has received the second kind error data from the maintenance server 5. The second kind error data is error data which is different from first kind error data.

The number of retries in step S6 is the number of times the CPU 11 determines in step S3 that the access to maintenance server 5 is not successful. The initial value of the number of retries is 0 (zero). The number of retries is incremented by 1 (one) each time the CPU 11 determines in step S3 that the access to the maintenance server 5 is not successful. The threshold value of step S6 may be set as appropriate and is stored in the memory 14. The threshold value in step 6 may be a value input by the owner, administrator, or user of the printer 1 by operating the input part 23.

In a case where the CPU 11 determines that the number of retries is equal to or less than the threshold value (step S6: YES), the CPU 11 returns the process to step S3. That is, after performing the message outputting process in step S5, the CPU 11 performs the first transmitting process again (step S3) in a case where the number of retries is equal to or less than the threshold value. In a case where the CPU 11 determines that the CPU 11 receives the second kind of error data (step S4: NO) and where the number of retries is equal to or less than the threshold value (step S6: YES), the CPU 11 performs the first transmitting process again (step S3), without outputting the message notifying of the occurrence of the error.

In a case where the CPU 11 determines that the number of retries exceeds the threshold value (step S6: NO), the CPU 11 ends the printer process. The CPU 11 may cause the display 24 to display an error message. The error message is, for example, "Failed to connect to the maintenance server".

In a case where the CPU 11 determines that the access to the maintenance server 5 is successful (step S3: YES), the CPU 11 of the printer A transmits an obtainment request to the maintenance server 5 via the communication part 21 (step S7). The obtainment request requests transmitting the management address, which corresponds to the printer 1, to the printer 1. The obtainment request includes a request to transmit the printer-related information. The obtainment request in the present embodiment includes a request to transmit the first printer ID and the segment ID. In a case where maintenance server 5 receives the obtainment request from the managed printer via the communication part 55, the maintenance server 5 transmits the management address to the printer 1.

In a case where the maintenance server 5 receives the obtainment request from a substitute printer via the communication part 55, the maintenance server 5 transmits the management address and substitute information to the printer 1. The substitute information is information indicating that the printer 1 is a substitute printer. The substitute information in the present embodiment includes the printer ID of a managed printer associated with the substitute printer.

The CPU 11 determines whether the CPU 11 has received data from the maintenance server 5 via the communication part 21 (step S8). The CPU 11 receives data including the management address from the maintenance server 5 via the communication part 21, in accordance with the first transmitting process of steps S3 and S7.

In a case where the print content data list corresponding to the template data does not exist, the management address indicates the source from which template data corresponding to the printer-related information is obtainable. The management address is set as appropriate to indicate the source from which the template data is obtainable. The management address in the present embodiment includes the URL of the management server 4, and the template ID of the template data corresponding to the printer 1. The template data is data for printing the predetermined print content based on the predetermined layout.

In a case where the print content data list corresponding to the template data exists, the management address indicates the source from which the print content data list including the identification information and the print content data indicating the print content is obtainable. The management address in the present embodiment includes the URL of the management server 4, the template ID of the template data corresponding to the printer 1, and the list ID.

In a case where the printer 1 is a substitute printer, the CPU 11 receives data including the substitute information in step S8. The substitute information indicates that the printer 1 is another printer 1 different from the printer 1, i.e., a substitute printer to be used as a substitute for the managed printer. The substitute information in the present embodiment includes the second printer ID for identifying another printer 1 different from the printer 1 which performs the process.

The CPU 11 stands by until the CPU 11 receives the data from the maintenance server 5 (step S8: NO). In a case where the CPU determines that the CPU 11 receives the data from the maintenance server 5 (step S8: YES), the CPU 11 causes the memory 14 to store the data including the management address (step S9). By performing the process of step S9, the CPU 11 sets the server to which the printer 1 is to connect next. Specifically, the CPU 11 causes the memory 14 to store the management address received in the first receiving process in step S8 to thereby set the server, to which the printer 1 is to connect next, to the management server 4 (step S9).

The CPU 11 accesses the management server 4, which is the same as or different from the maintenance server 5, using the management address and the printer-related information, and determines whether the access is successful (step S10). In step S10, the CPU 11 performs the process of establishing the communication connection, such as the handshaking, between the management server 4 and the printer 1. In a case where the printer 1 which has accessed the management server 4 fails to access the management server 4, the management server 4 transmits error data indicating an error to the printer 1. The CPU 11 determines that the access is successful in a case where the CPU 11 does not receive the error data from the management server 4 via the communication part 21.

In a case where the CPU 11 determines that the access to the management server 4 is not successful (step S10: NO), the CPU 11 determines whether the number of retries is equal to or less than a threshold value (step S15). The number of retries in step S15 is the number of times the CPU 11 determines in step S10 that the access to the management server 4 is not successful.

The initial value of the number of retries is 0 (zero). The number of retries is incremented by 1 (one) each time the CPU 11 determines that the access to the maintenance server 5 is not successful in step S10. The threshold value in step S15 may be set as appropriate and is stored in the memory 14. The threshold value in step S15 may be the same as or different from the threshold value in step S6.

In a case where the CPU 11 determines that the number of retries is equal to or less than the threshold value (step S15: YES), the CPU 11 returns the process to step S10. In a case where the CPU 11 determines that the number of retries exceeds the threshold value (step S15: NO), the CPU 11 ends the printer process. The CPU 11 may cause the display 24 to display an error message. The error message is, for example, "Failed to connect to the management server".

In a case where the CPU 11 determines that the access to the management server 4 is successful (step S10: YES), the CPU 11 determines whether the data received in step S8 includes the substitute information (step S16). In a case where the data received in step S8 includes the substitute information, the substitute printer performs the printer process. The CPU 11 of the printer A in Specific Example 1 determines that the data received in step S8 does not include the substitute information (step S16: NO).

The CPU 11 transmits a registration request to the management server 4 via the communication part 21 (step S17). The registration request in step S17 requests to register the printer 1 with the management server 4 as a managed printer and to transmit, to the printer 1, the template data corresponding to the printer 1. The registration request in the present embodiment requests the transmission of the print content data list corresponding to the template data, in addition to the template data. The registration request in step S17 includes the printer-related information, and the status data indicating the status of the printer 1.

The CPU 11 determines whether the CPU has received the data from the management server 4 via the communication part 21 (step S18). In a case where the CPU 11 determines that the server to which the printer 1 is to connect next is the maintenance server 5 and where the CPU performs the printer process in the first mode (step S1: YES), the CPU 11 performs a second receiving process of step 18 via the communication part 21, after the CPU 11 has performed the first receiving process.

The CPU 11 in the present embodiment receives, in a predetermined case, data including the template data corresponding to the printer 1 and the print content data-related information, via the communication part 21. The template data corresponding to the printer 1 is identified by the URL and the template ID in the management server 4. The print content data-related information in the present embodiment is the print content data list. The print content data-related information is identified by the URL and the list ID in the management server 4.

The plurality of printers 1 in the present embodiment include printer(s) configured to be capable of performing printing in the template print mode and printer(s) not capable of performing printing in the template print mode. The predetermined case is a case where the printer 1 is a printer which is capable of performing printing in the template print mode.

In the template print mode, the CPU 11 uses a special code for applying the print content to the layout indicated by the template data so as to perform the printing. The special code includes, for example, a code indicating the template ID. The special code may also include a code indicating the list ID. The special code does not include the image data based on the template data or the image data based on the template data and the print content data. In the normal print mode, the CPU 11 performs the printing of the print image in accordance with the image data indicating the print image. In the normal print mode, the special code of the template print mode is not used. In the normal print mode, the CPU 11 receives a print instruction which includes the image data based on the template data, or the image data based on the template data and the print content data.

The CPU 11 stands by until the CPU 11 receives the data (step S18: NO). In a case where the CPU 11 receives the data from the management server 4 via the communication part 21 (step S18: YES), the CPU 11 causes the memory 14 to store the received data (step S19).

The CPU 11 determines whether the data received in step S18 includes a transition instruction (step S20). The transition instruction is an instruction for transitioning to the template print mode in which printing is performed using the template data stored in the memory 14. The transition instruction is transmitted from the management server 4 in a case where the printer 1 is a printer which is capable of performing printing in the template print mode.

In a case where the CPU 11 determines that the data received in step S18 includes the transition instruction (step S20: YES), the CPU 11 transitions from the normal print mode to the template print mode (step S21). In a case where the CPU determines that the data received in step S18 does not include the transition instruction (step S20: NO), or after step S21, the CPU 11 ends the printer process.

A case where the printer A in Specific Example 2 performs the printer process will be described, with reference to FIGS. 3B, 5A and 5B, 7A and 7B and 8. The CPU 11 of the printer A in Specific Example 2 determines that the printer process is not performed in the first mode (step S1: NO). The CPU 11 performs the printer process in the second mode (step S24).

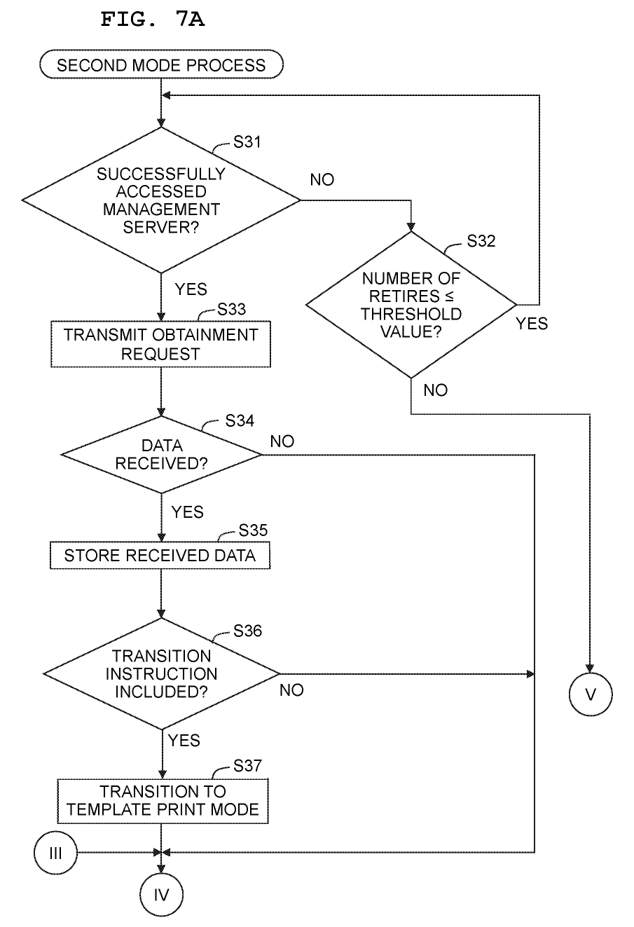

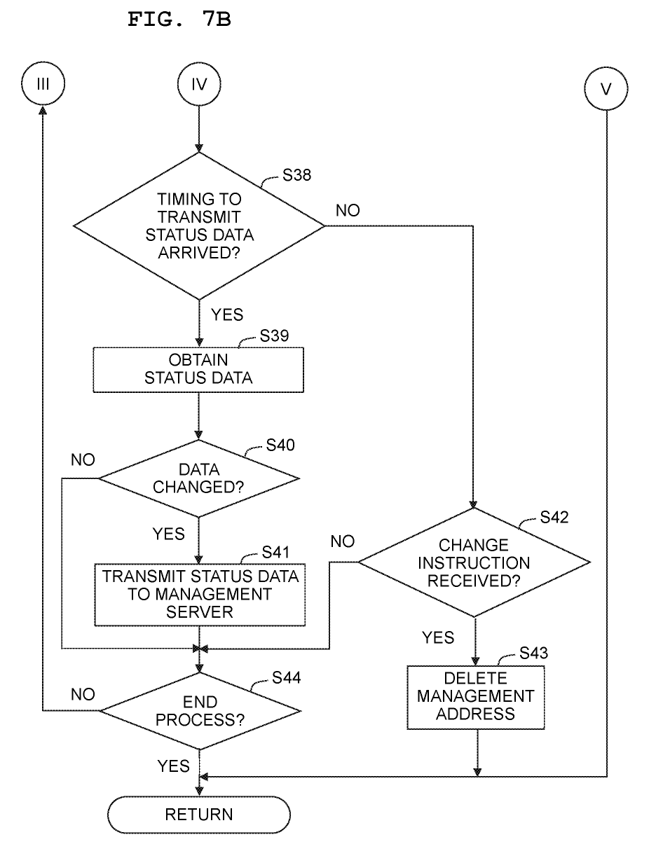

As illustrated in FIGS. 7A and 7B, in the printer process performed in the second mode, the CPU 11 accesses the management server 4 using the management address and the printer-related information stored in the memory 14. In a case where the server to which the printer A is to connect next is the management server 4, and where the printer process is performed in the second mode (step S1: NO), the CPU 11 does not perform the first receiving process. The CPU 11 determines whether the access to the maintenance server 4 is successful (step S31). In step S31, the process of establishing the communication connection, such as the handshaking, between the management server 4 and the printer 1 is performed.

In a case where the CPU 11 determines that the access to the management server 4 is not successful (step S31: NO), the CPU 11 determines whether the number of retries is equal to or less than a threshold value (step S32), similarly to step S15. In a case where the CPU 11 determines that the number of retries is equal to or less than the threshold value (step S32: YES), the CPU 11 returns the process to step S31. In a case where the CPU 11 determines that the number of retries exceeds the threshold value (step S32: NO), the CPU 11 ends the printer process performed in the second mode, and returns the process to the printer process.

In a case where the CPU 11 determines that the access to the management server 4 is successful (step S31: YES), the CPU 11 transmits an obtainment request to the management server 4 via the communication part 21 (step S33). The obtainment request requests the transmission of the template data corresponding to the printer 1 to the printer 1. The obtainment request in the present embodiment requests the transmission of the print content data list corresponding to the template data, in addition to the template data. The obtainment request includes the printer-related information and the status data. The CPU 11 determines whether the CPU 11 has received the data from the management server 4 via the communication part 21 (step S34). In a case where the CPU 11 determines that the CPU 11 has not received the data (step S34: NO), the CPU 11 performs the process of step S38.

In a case where the CPU 11 determines that the CPU 11 has received the data (step S34: YES), the CPU 11 causes the memory 14 to store the received data (step S35). The CPU 11 determines whether the data received in step S34 includes the transition instruction (step S36). In a case where the CPU 11 determines that the data received in step S34 includes the transition instruction (step S36: YES), the CPU transitions from the normal print mode to the template print mode (step S37). In a case where the CPU 11 determines that the data received in step S34 does not include the transition instruction (step S36: NO), or after step S37, the CPU 11 determines whether a timing to transmit the status data has arrived (step S38). In a case where a predetermined cycle has elapsed since the obtainment request has been transmitted in step S33, or in a case where a predetermined cycle has elapsed since the last time the CPU 11 has obtained the status data in step S39, the CPU 11 determines that the timing to transmit the status data has arrived. The predetermined cycle may be set appropriately and may be stored in the memory 14.

The status data is data indicating, for example, the status of the printer 1, the print history, etc. The status of the printer 1 indicates, for example, whether the printer 1 is operating normally or is out of service. The status data corresponding to a case where the printer is out of service also includes the kind of error.

The print history is indicated, for example, by a number of sheets printed and the template ID. The template ID included in the status data is data which identifies the template data used for the printing. The status may include, for example, the remaining amount of a consumable item, the firmware version, etc. The consumable item is, for example, the print medium 3.

In a case where the CPU 11 determines that the timing to transmit the status data has arrived (step S38: YES), the CPU 11 obtains the status data (step S39). The CPU 11 causes the RAM 13 or the memory 14 to store the status data while associating the date and time of obtainment with the status data. The CPU 11 determines whether the newly obtained status data in step S39 is different from the status data which has been previously obtained in step S39 and stored in the RAM 13 or the memory 14 (step S40).

In a case where the CPU 11 determines that the status data newly obtained in step S39 is the same as the status data obtained previously in step S39 (step S40: NO), the CPU 11 performs a process of step S44. In a case where the CPU 11 determines that the newly obtained status data in step S39 is different from the status data previously obtained in step S39 (step S40: YES), the CPU 11 performs a process of step S41. The CPU 11 transmits the status data obtained in step S39 to the management server 4 via the communication part 21 (step S41).

In a case where the CPU 11 determines that the timing to transmit the status data has not arrived (step S38: NO), the CPU 11 determines whether the CPU 11 has received a change instruction from the management server 4 via the communication part 21 (step S42). The management server 4 transmits the change instruction to the printer A in a case where the management server 4 cancels the registration of the printer A as the managed printer of the segment X. In a case where the CPU 11 determines that the CPU 11 has received the change instruction from the management server 4 via the communication part 21 (step S42: YES), the CPU 11 deletes the management address stored in the memory 14 (step S43). With the process of step S43, the next connection address becomes the maintenance address. In other words, the CPU 11 deletes the management address from the memory 14 (step S43) to thereby set the server, to which the printer A is to connect next, to the maintenance server 5.

In a case where the CPU 11 determines that the CPU 11 has not received the change instruction from the management server 4 via the communication part 21 (step S42: NO), or after step S41, the CPU 11 performs a process of step S44. The CPU 11 determines whether to end the printer (step S44). In a case where the power of the printer 1 is turned OFF, the CPU 11 determines that the printer process is to be ended (step S44).

In a case where the CPU 11 determines that the printer process is not to be ended (step S44: NO), the CPU 11 returns the process to step S38. In a case where the CPU 11 determines that the printer process is to be ended (step S44: YES), the CPU 11 ends the printer process performed in the second mode and returns the process to the printer process.

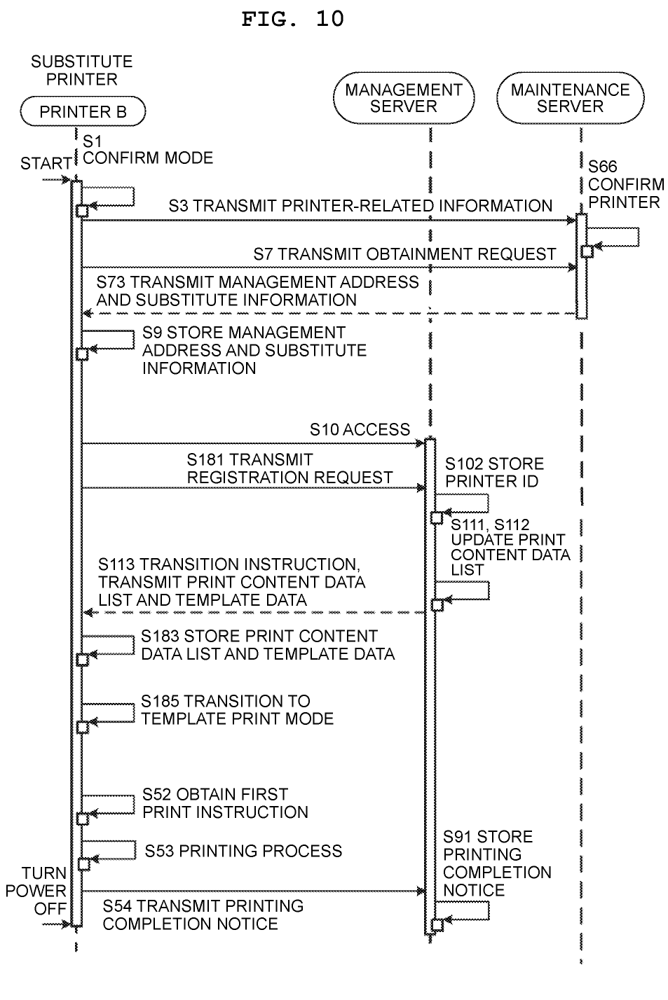

A case in which the printer B in Specific Example 3 performs the printer process will be described, with reference to FIGS. 4A, 5A and 5B, 9 and 10. The CPU 11 of the printer B in Specific Example 3 determines that the printer process is to be performed in the first mode (step S1: YES). The CPU 11 performs the processes of steps S3 to S7 in a similar manner to the printer process in the case regarding the printer A in Specific Example 1. The CPU 11 receives data including the substitute information from the management server 4 via the communication part 21 (step S8). The CPU 11 causes the memory 14 to store the data received in step S8 (step S9).

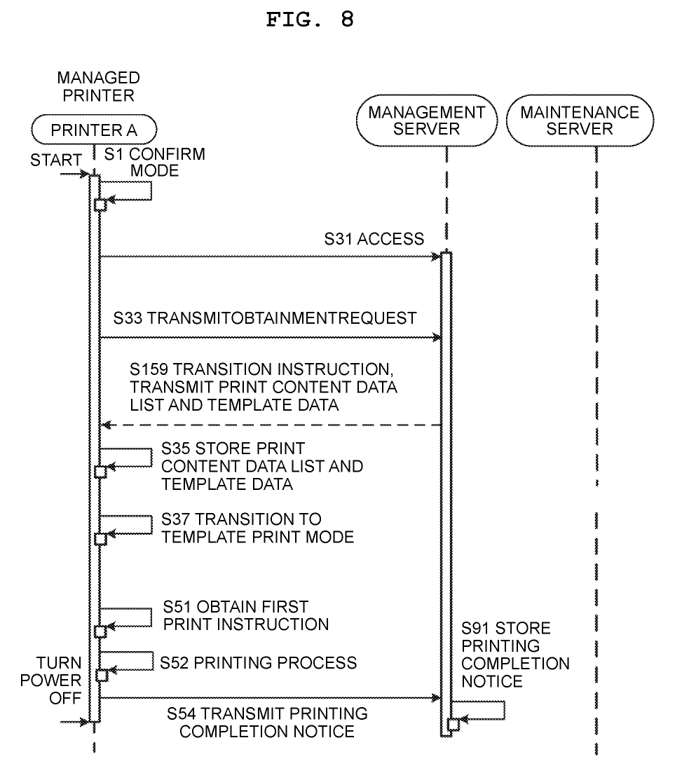

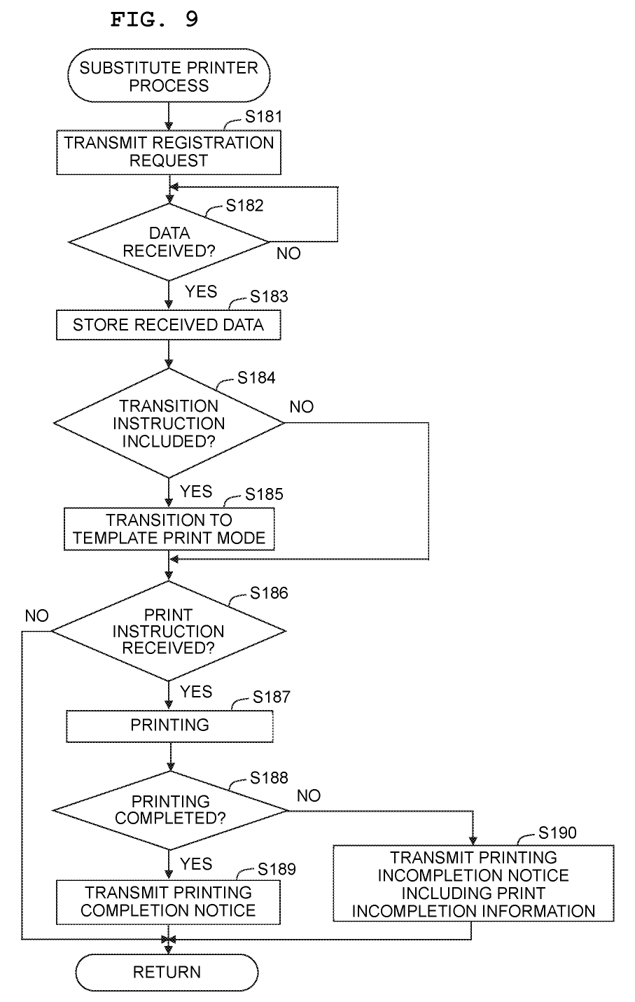

The CPU 11 performs the processes of the S10 and S15 in a similar manner to the printer process in the case of the printer A in Specific Example 1. The CPU 11 determines in step S16 that the data received in step S9 includes the substitute information (step S16: YES) and performs a substitute printer process (step S23). In the substitute printer process, as illustrated in FIG. 9, the CPU 11 transmits the registration request to the management server 4 via the communication part 21 (step S181). The registration request of step S181 requests that the printer B be registered with the management server 4 as a substitute printer to be used as a substitute for the managed printer. The registration request of step S181 requests that the template data, and the print content data list corresponding to the template data be transmitted to the printer 1. The registration request in the present embodiment requests that the print content data list corresponding to the template data be transmitted, in addition to the template data. The registration request corresponding to a case where the printer 1 is the substitute printer includes the substitute information, in addition to the printer-related information and the status data.

The CPU 11 determines whether the CPU 11 has received the data from the management server 4 via the communication part 21 (step S182). In a predetermined case, the CPU 11 in the present embodiment receives, via the communication part 21, data including the template data, the print content data-related information, and the print history corresponding to another printer 1 different from the printer 1 which performs the process. The predetermined case is a case where the printer 1 is a printer which is capable of performing the printing in the template print mode.

The another printer 1 which is different from the printer B in Specific Example 3 is the printer A. The template data corresponding to the another printer 1 is identified by the URL and the template ID in the management server 4. The print content data-related information is the print content data list. The print content data-related information is identified by the URL and the list ID in the management server 4.

The print history is a print history of the another printer 1 indicated by the substitute information in a predetermined period. The predetermined period may be set as appropriate. The print history is used by the owner, administrator, or user of the printer 1 and the another printer 1 to confirm the print history.

The CPU 11 stands by until the CPU 11 receives the data (step S182: NO). In a case where the CPU 11 receives the data from the management server 4 via the communication part 21 (step S182: YES), the CPU 11 causes the memory 14 to store the data (step S183).

The CPU 11 determines whether the data received in step S182 includes a transition instruction (step S184). In a case where the CPU 11 determines that the data received in step S182 includes the transition instruction (step S184: YES), the CPU 11 transitions from the normal print mode to the template print mode (step S185). In a case where the CPU 11 determines that the data received in step S182 does not include the transition instruction (step S184: NO), or after S185, the CPU 11 performs a process of step S186.

The CPU 11 determines whether the CPU 11 has received the first print instruction or the second print instruction from the management server 4 via the communication part 21 (step S186). In a predetermined case, the CPU 11 receives the first print instruction or the second print instruction from the management server 4 via the communication part 21 (step S186). The predetermined case is a case where printing incompletion information, indicating an incomplete print job using the template data, is present in another printer 1 different from the printer 1 which performs the process.

The first print instruction includes the template ID for identifying the template data, and the print content data-related information related to the print content data indicating the print content. The print content data-related information may be any information which contributes to identifying the print content data. The print content data-related information in the present embodiment is the identification information. The print content data-related information may also be the list ID. The second print instruction includes the image data indicating a print image based on the print content data and the template data. The first print instruction is the print instruction for performing printing in the template print mode. The second print instruction is the print instruction for performing printing in the normal print mode.

In a case where the CPU 11 determines that the CPU 11 has received neither the first print instruction nor the second print instruction from the management server 4 via the communication part 21 (step S186: NO), the CPU 11 ends the substitute printer process, and returns the process to the printer process. In a case where the CPU 11 determines that the CPU 11 has received the first or second print instruction from the management server 4 via the communication part 21 (step S186: YES), the CPU 11 causes the print head 26 to perform printing of a print image based on the received print instruction (step S187). The print image corresponding to a case where the CPU 11 has obtained the first print instruction is an image in which the print content is applied to the layout indicated by the template data associated with the template ID. The print content is identified based on the first print instruction. The print image corresponding to a case where the CPU 11 has obtained the second print instruction is an image indicated by the image data based on the second print instruction.

The CPU 11 determines whether the printing based on the print instruction is completed (step S188). The CPU 11 determines that the printing based on the print instruction is completed, in a case where no error has occurred during the printing, and where the printing has not been interrupted. In a case where the CPU 11 determines that the printing based on the print instruction is completed (step S188: YES), the CPU 11 transmits a printing completion notice to the management server 4 via the communication part 21 (step S189). The printing completion notice includes the template ID and the identification information of the template used for the printing.

In a case where the CPU 11 determines that the printing based on the print instruction is not completed (step S188: NO), the CPU 11 transmits a printing incompletion notice to the management server 4 via the communication part 21 (step S190). The printing incompletion notice includes the printing incompletion information. The printing incompletion notice in the present embodiment includes the template ID of the template used for the printing, the identification information, and the printing incompletion information.

The printing incompletion information includes data indicating an incomplete print job. The printing incompletion information of the print job based on the first print instruction includes the template ID and the print content data-related information included in the first print instruction. The printing incompletion information of the print job based on the second print instruction includes the image data included in the second print instruction. The case where the printing based on the print instruction is not completed is a case where the printing has failed or the printing has been interrupted.

In a case where the template data includes a layout of sequentially numbered print contents, the printing incompletion notice may include the number of sheets to be printed and the number of sheets on which printing has been completed. The sequentially numbered print content is a print content in which numbers for managing the order (of printing) are printed in sequential numbers. After performing the process of step S189 or step S190, the CPU 11 ends the substitute printer process, and returns the process to the printer process. The printer B may perform the process of transmitting the status data to the management server 4 in the substitute printer process, in a similar manner to the processes in steps S38 to S44. The CPU 11 ends the printer process after step S23.

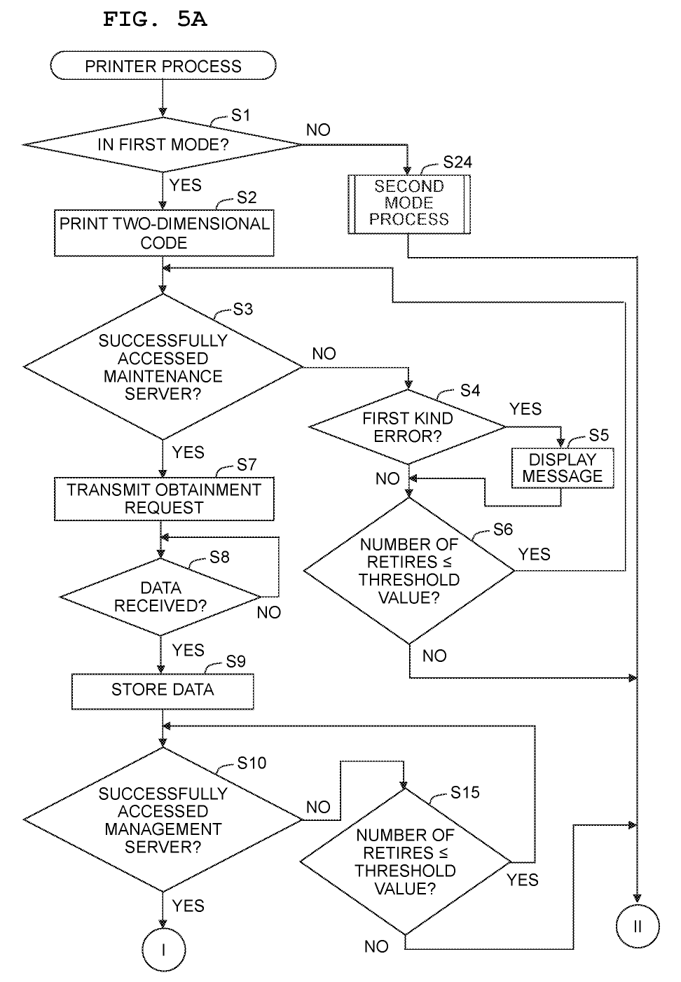

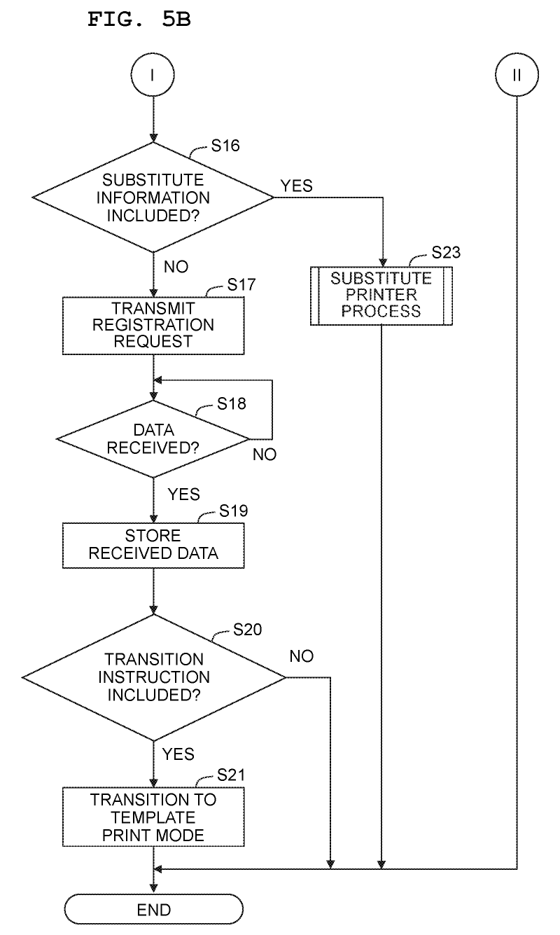

A case in which the printer C in Specific Example 4 performs the printer process will be described, with reference to FIGS. 4B and 5. The CPU 11 of the printer C in Specific Example 4 determines that the printer process is to be performed in the first mode (step S1: YES). The CPU 11 prints a two-dimensional code (step S2). The CPU 11 accesses the maintenance server 5 using the maintenance address stored as the next connection address. The CPU 11 transmits the printer-related information related to the printer 1 (the printer C) to the maintenance server 5 via the communication part 21 (step S3).

The maintenance server 5 uses the printer-related information to determine that the printer C accessing the maintenance server 5 has not been previously registered with the maintenance server 5. The maintenance server 5 transmits the first kind error data to the printer C. The CPU 11 of the printer C determines that the access to the maintenance server 5 is not successful (step S3: NO). The CPU 11 determines that the CPU 11 has received the first kind error data from the maintenance server 5 via the communication part 21 (step S4: YES). The CPU 11 causes the display 24 to display a message (step S5); in a case where the number of retries exceeds a threshold value (step S6: NO), the CPU 11 ends the printer process. The CPU 11 may perform the process of step S5 only once in a case where the CPU 11 determines that the CPU 11 has received the first kind error for the first time.

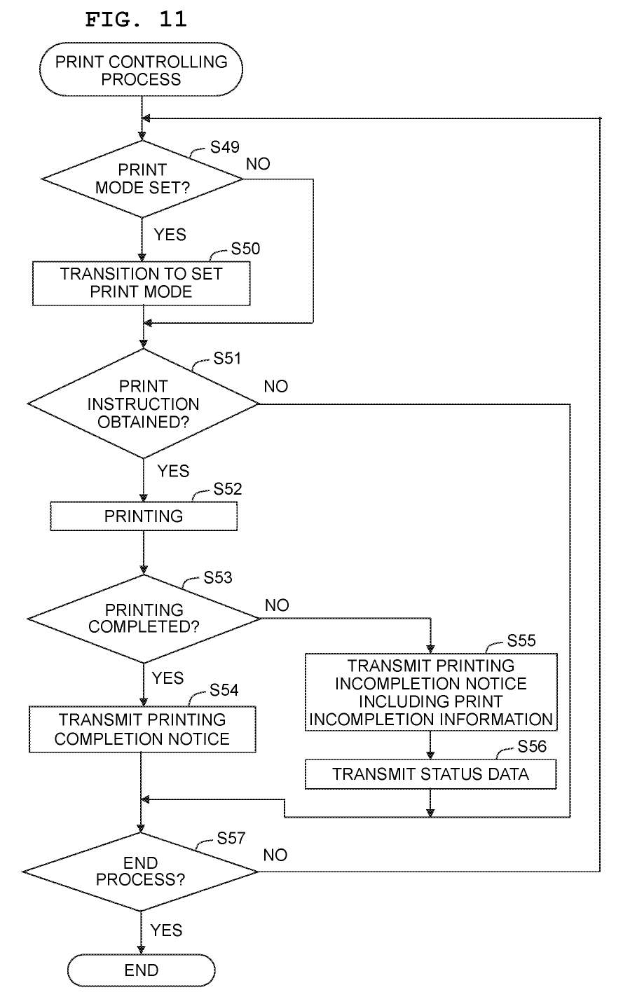

A print controlling process performed by the CPU 11 of the printer 1 will be described, with reference to FIG. 11. As an example, a case where the printer B prints the print image 77, as a substitute printer for the printer A, will be described. The CPU 11 of the printer B reads the program for performing the printer process from the memory 14 to the RAM 13, in a case where the power of the printer B is turned on. The program includes an instruction for causing the CPU 11 to perform the following process. The CPU 11 performs the following steps in accordance with the instruction included in the program read to the RAM 13.

The CPU 11 determines whether the CPU 11 has accepted a setting of the print mode via the input part 23 (step S49). The user of the printer 1 can operate the input part 23 to input the setting of the print mode. The printer 1 in the present embodiment is configured to be capable of performing printing in each of the normal print mode and the template print mode.

The normal print mode is a mode in which a print image indicated by image data is printed, based on the image data. The image data in normal print mode is image data based on the template data, or image data based on the template data and the print content data. The template print mode is a mode in which a print image is printed based on the template data and the print content data-related information.

In a case where the CPU 11 determines that the CPU 11 has accepted the setting of the print mode (step S49: YES), the CPU 11 transitions to the print mode in accordance with the setting (step S50). In a case where the CPU 11 determines that the CPU 11 has not accepted the setting of the print mode (step S49: NO), or after step S50, the CPU 11 performs a process of step S51. The CPU 11 determines whether the CPU 11 has obtained the first print instruction or the second print instruction via the input part 23 (step S51). The user can operate the input part 23 to input the first print instruction. The user can also transmit the first print instruction or the second print instruction to the printer 1 using the terminal device 8.

In a case where the CPU 11 determines that the CPU has not obtained the first print instruction or the second print instruction (step S51: NO), the CPU 11 performs a process of step S57. In a case where the CPU 11 determines that the CPU has obtained the first print instruction or the second print instruction (step S51: YES), the CPU 11 causes the print head 26 to print the print image based on the obtained print instruction (step S52).

The CPU 11 determines whether the printing based on the print instruction is completed in the process of step S52 (step S53). The CPU 11 determines that the printing based on the print instruction is completed in a case where no error has occurred during the printing and where the printing has not been interrupted. In a case where the CPU 11 determines that the printing based on the print instruction is completed (step S53: YES), the CPU 11 transmits a printing completion notice to the management server 4 via the communication part 21 (step S54). The CPU 11 performs a process of step S54 in a similar manner to the process of step S189.

In a case where the CPU 11 determines that the printing based on the print instruction is not completed (step S53: NO), the CPU 11 transmits the printing incompletion notice including the printing incompletion information to the management server 4 via the communication part 21 (step S55). The CPU 11 performs the process of step S55 in a similar manner to the process of step S190. The CPU 11 transmits the status data to the management server 4 via communication part 21 (step S56), After the processes of step S54 or step S56, the CPU 11 determines whether to end the print controlling process (step S57). The CPU 11 determines that the print controlling process is to be ended in a case where the printer 1 power is turned off.

In a case where the CPU 11 determines that the print controlling process is not to be ended (step S57: NO), the CPU 11 returns the process to step S49. In a case where the CPU 11 determines that the printer process is to be ended (step S57: YES), the CPU 11 ends the print controlling process.

A maintenance server process, which is performed by the CPU 51 of the maintenance server 5, will be described with respect to Specific Example 1 and with reference to FIGS. 3A, 6, 12, and 13A. In a case where the power of the maintenance server 5 is turned on, the CPU 11 reads a program for performing the maintenance server process from the memory 54 to the RAM 53. The program for performing the maintenance server process includes an instruction for causing the CPU 51 to perform the following process. The CPU 51 performs the following steps in accordance with the instruction included in the program read to the RAM 53.

As illustrated in 12, the CPU 51 determines whether the CPU 51 has received the registration request, via the communication part 55, from another device different from the printer 1 (step S61). The another device different from the printer 1 is, for example, a terminal device 8, as illustrated at FIG. 1, which is used by the owner, administrator, or user of the printer 1.

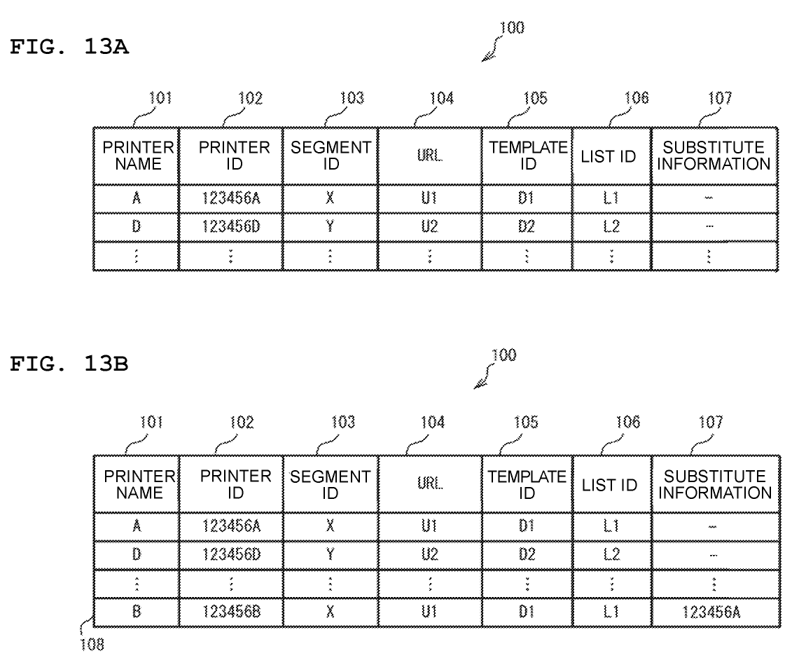

In a case where the CPU 51 determines that the CPU 51 has received the registration request via the communication part 55 (step S61: YES), the CPU 51 causes the memory 54 to store a registration content indicated by the received registration request, based on the received registration request (step S62). The maintenance server 5 causes the memory 54 to store a table 100 as illustrated in FIG. 13A. The CPU 51 registers data with the table 100, in accordance with the registration request.

The table 100 stores a printer name 101, a printer ID 102, a segment ID 103, a URL 104, a template ID 105, a list ID 106, and substitute information 107 in association with one another. The printer name 101 indicates the name of the printer 1. The URL 104 indicates the address of the management server 4.

Template ID 105 is data for identifying template data associated with the printer 1. The list ID 106 is data for identifying the print content data list associated with the template data. Each of the template ID 105 and the list ID 106 in the present embodiment is indicated, as an example, by a string of an alphabetic character combined with a number.

The substitute information 107 is data indicating whether the printer 1 is a substitute printer. In a case where the substitute information 107 has a null value, that is, in a case where no data is stored in the substitute information 107, the substitution information 107 indicates that the printer 1 is not a substitute printer. In a case where a printer ID is stored in the substitute information 107, the substitution information 107 indicates that the printer 1 is a substitute printer to be used as a substitute for the managed printer indicated by the printer ID.

In a case where the registration request includes the management address and the printer-related information, the CPU 51 causes the memory 54 to store the management address and the printer-related information in the table 100, while associating the management address with the printer-related information with each other. In a case where the registration request includes the template ID, the CPU 51 causes the memory 54 to store the management address including the URL of the management server 4 and the template ID, in the table 100. In a case where the registration request includes the template ID and the list ID, the CPU 51 causes the memory 54 to store the URL of the management server 4, the template ID and the list ID, in the table 100. In a case where the registration request includes the substitute information, the CPU 51 causes the memory 54 to store the first printer ID for identifying the printer 1, and the substitute information, in the table 100, while associating the first printer ID and the substitute information with each other.

The CPU 51 returns the process to step S62. In a case where the CPU 51 determines that the CPU 51 has not received the registration request via the communication part 55 (step S61: NO), the CPU 51 determines whether the CPU 51 has received the status data from the management server 4 via the communication part 55 (step S63). In a case where the CPU 51 determines that the CPU 51 has received the status data from the management server 4 via the communication part 55 (step S63: YES), the CPU 51 performs a process of step S64. The CPU 51 causes the memory 54 to store the status data, while associating the status data with the printer ID (step S64). The CPU 51 returns the process to step S61.

In a case where the CPU 51 determines that the CPU 51 has not received the status data from the management server 4 via the communication part 55 (step S63: NO), the CPU 51 determines whether the maintenance server 5 has been accessed by the printer 1 (step S65). The CPU 51 determines that the maintenance server 5 has been accessed by the printer in a case where the CPU 51 has received, via the communication part 55, the printer-related information from the printer 1 which has accessed the maintenance server 5. In a case where the CPU 51 determines that the maintenance server 5 has not been accessed by the printer 1 (step S65: NO), the CPU 51 returns the process to step S61.

In a case where the CPU 51 determines that the maintenance server 5 has been accessed by the printer A in Specific Example 1 (step S65: YES), the CPU 51 determines whether the maintenance server 5 has been accessed by the printer 1 registered with the maintenance server 5 (step S66). The CPU 51 performs the process of step S65 based on the printer-related information received from the printer 1 via the communication part 55, and based on the table 100. Specifically, in a predetermined case, the CPU 51 determines that the maintenance server 5 has been accessed by the printer 1 registered with the maintenance server 5. The predetermined case is a case where the printer ID included in the printer-related information is stored in the printer ID 102 of the table 100.

In a case where the CPU 51 determines that the maintenance server 5 has been accessed by a printer 1 which is not registered with the maintenance server 5 (step S66: NO), the CPU 51 performs a process of step S74. The CPU 51 transmits the first kind error data to the printer 1 in a predetermined case. The predetermined case is a case where the first printer ID of the printer which has accessed the maintenance server 5 using the maintenance address is not stored in the memory 54 (step S66: NO). The first kind error data indicates that the first printer ID is not stored in the memory 54.

In a case where the CPU 51 determines that the maintenance server 5 has been accessed by the printer A in Specific Example 1, the CPU 51 determines that the maintenance server 5 has been accessed by the printer 1 registered with the maintenance server 5 (step S66: YES). The CPU 51 determines whether the printer A has successfully accessed the maintenance server 5 (step S67). In a case where the CPU 51 determines that the printer A has failed to access the maintenance server 5 (step S67: NO), the CPU 51 performs a process of step S68. The CPU 51 transmits the second kind error data, which is different from the first kind error data, to the printer A, in a predetermined case (step S68). The predetermined case is a case where the first printer ID of the printer 1 which has accessed the maintenance server 5 using the maintenance address is stored in the memory 54, but the management address corresponding to the printer 1 cannot be transmitted to the printer 1.

In a case where the CPU 51 determines that the printer A has successfully accessed the maintenance server 5 (step S67: YES), the CPU 51 performs a process of step S69. The CPU 51 determines whether the CPU 51 has received an obtainment request via communication part 55 from the printer A successfully accessed the maintenance server 5 in step S67 (step S69). In a case where the CPU 51 determines that the CPU 51 has not received the obtainment request from the printer A (step S69: NO), the CPU 51 returns the process to step S61. In a case where the CPU 51 determines that the CPU 51 has received the obtainment request from the printer A (step S69: YES), the CPU 51 performs a management address transmitting process of transmitting the predetermined management address to the printer 1 (step S72, step S73).

Specifically, the CPU 51 determines whether the printer A successfully accessed the maintenance server 5 in step S67 is a substitute printer (step S71). The CPU 51 refers to the table 100 and determines that the printer A is the substitute printer in a predetermined case. The predetermined case is a case where a value is stored in the substitute information 107 associated with the printer ID included in the printer-related information.

In a case where the CPU 51 determines that the printer A is the substitute printer (step S71: YES), the CPU 51 transmits, to the printer A, the management address and the substitute information corresponding to the printer A (step S73). In a case where the CPU 51 determines that the printer A is not the substitute printer (step S71: NO), the CPU 54 transmits the management address corresponding to the printer A to the printer 1 (step S72). The management address transmitted in each of step S72 and step S73 includes the URL of the management server 4, the template ID, and the list ID. The management address corresponding to the printer A includes a URL "U1", a template ID "D1", and a list ID "L1".

After step S73 or step S72, the CPU 51 returns the process to step S61. The CPU 51 ends the maintenance server process in a case where the maintenance server 5 is turned off.

The maintenance server process corresponding to a case where the printer B in Specific Example 3 accesses the maintenance server 5 will be described, with reference to FIGS. 4A, 10, 12, 13A, and 13B. In a case where the printer B in Specific Example 3 accesses the maintenance server 5 (step S65: YES), the CPU 51 of maintenance server 5 performs the following process. Since the printer-related information of the printer B is not stored in table 100 of FIG. 13A (step S66: NO), the CPU 51 performs the process of step S74. The CPU 51 transmits the first kind error data to the printer B via the communication part 55 (step S74).

In a case where the CPU 51 determines that the CPU 51 has received a registration request including the printer ID of the printer B from the terminal device 8 (step S61: YES), the CPU 51 performs the following process. The CPU 51 adds a registration content 108 indicated by the registration request to the memory 54 based on the received registration request, as illustrated in FIG. 13B, and causes the memory 54 to store the registration content 108.

In a case where the CPU 51 determines that the printer B in Specific Example 3 has accessed the maintenance server 5 (step S65: YES), the CPU 51 of the maintenance server 5 performs the following process. The CPU 51 determines that the printer-related information of the printer B is stored in the table 100 of FIG. 13B (step S56: YES). The CPU 51 determines that the printer B is a substitute printer (step S71: YES). The CPU 51 transmits, to the printer B, the management address and the substitute information corresponding to the printer B (step S73). The management address corresponding to the printer B is the same as the management address corresponding to the printer A.

A management server process which is performed by the CPU 41 of the management server 4 will be described with respect to Specific Example 2 and with reference to FIGS. 3B, 8, 14 to 20. The CPU 41 of the management server 4 reads a program for performing the management server process from the memory 44 to the RAM 43, in a case where the power of the management server 4 is turned on. The program includes an instruction for causing the CPU 41 to perform the following process. The CPU 41 performs the following steps in accordance with the instruction included in the program read into the RAM 43.

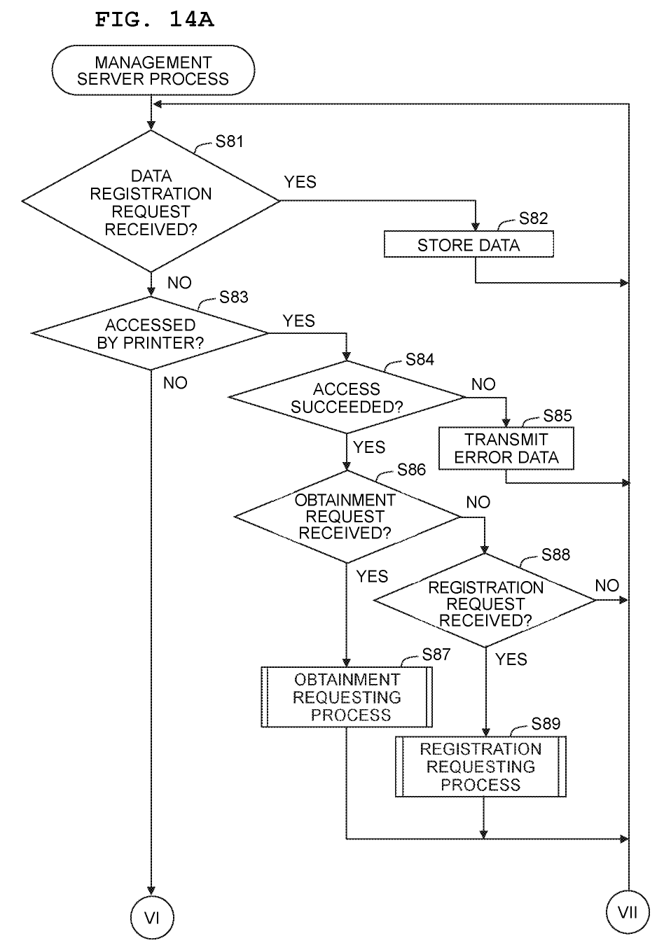

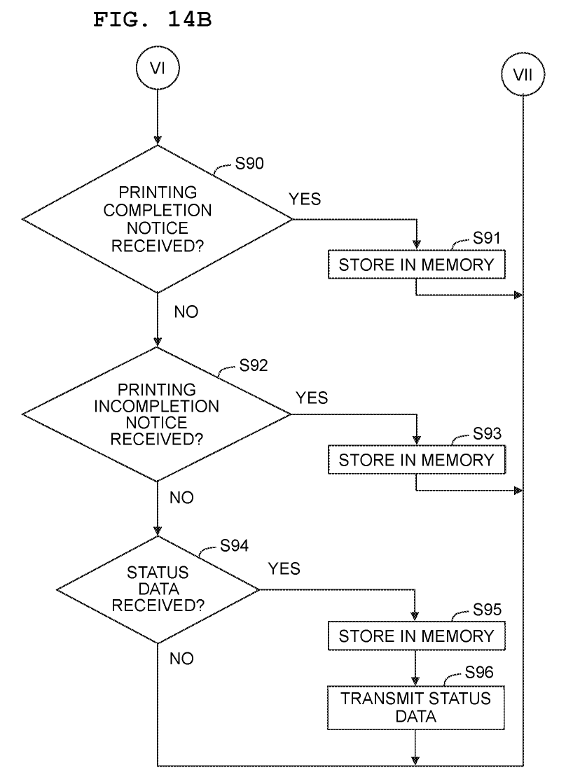

As illustrated in FIGS. 14A and 14B, the CPU 41 of the management server 4 determines whether the CPU 51 has received a data registration request to register data with the management server 4, via the communication part 45 (step S81). The data registration request is transmitted to the management server 4 by the owner, administrator, or user of the printer 1 operating the terminal device 8. The data registration request includes an instruction for updating tables 60 and 66 in the memory 44.

The data regarding the managed printer includes a printer ID of the managed printer, template data, and a print content data list. In a case where the CPU 41 has received the data registration request via the communication part 45 (step S81: YES), the CPU 41 causes the memory 44 to store the data included in the data registration request (step S82). The CPU 41 causes the memory 44 to store the template data corresponding to the printer 1 for each of the plurality of management addresses.

In the printer system 7 in the present embodiment, a management address, a number of managed printers, and a number of operational printers are managed for each of the segments. The number of managed printers is the number of printers 1 which are associated with the segment ID, and is the maximum number of printers 1 to be managed by the management server 4. The number of managed printers is set by the administrator of the printers 1. The number of managed printers is the number of printers 1 which are actual targets to be managed by the management server 4. The number of operational printers does not include the number of printer(s) which are out of service.

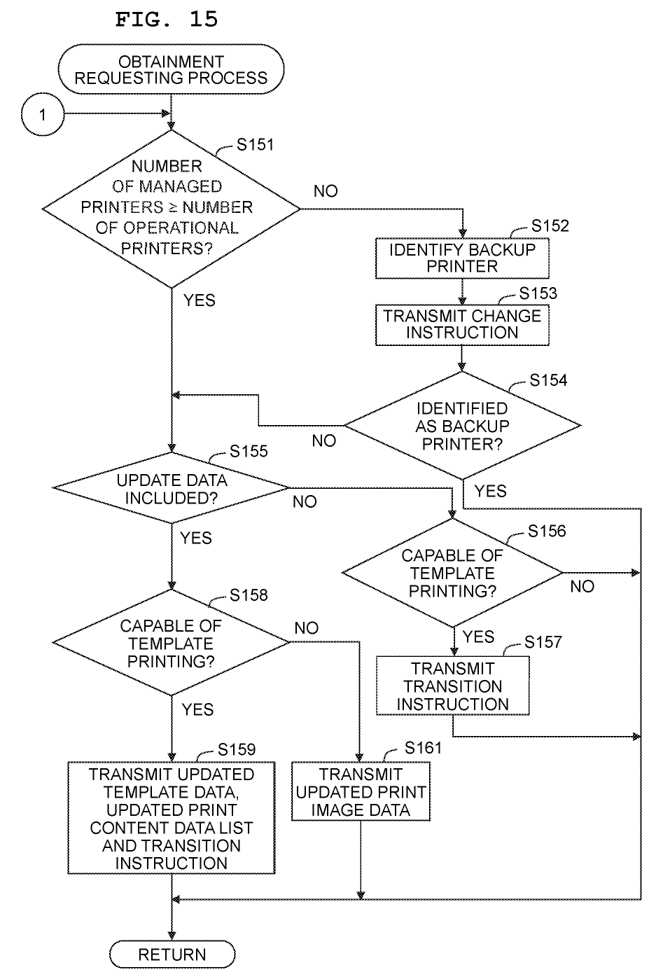

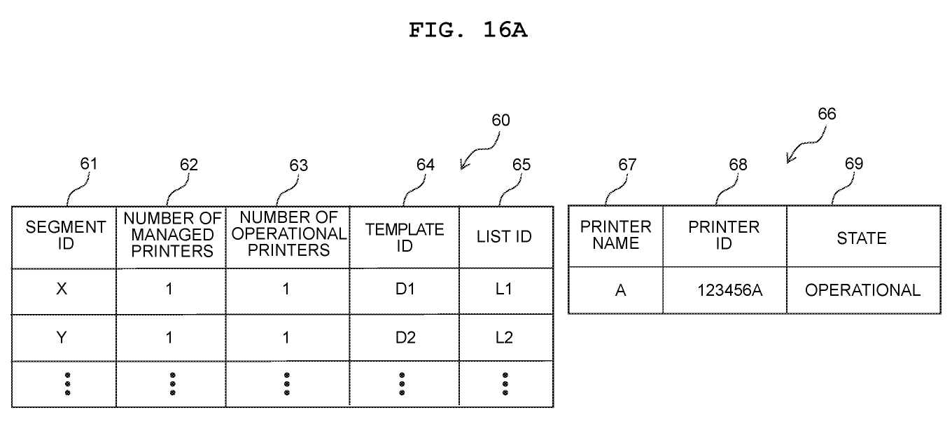

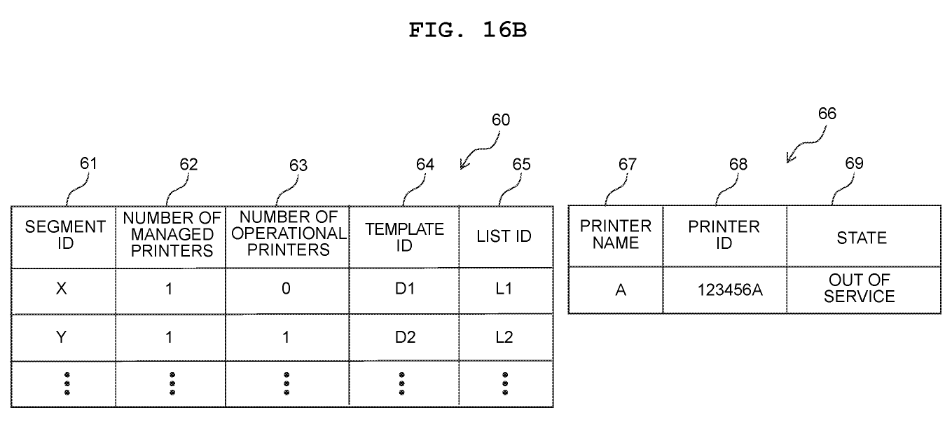

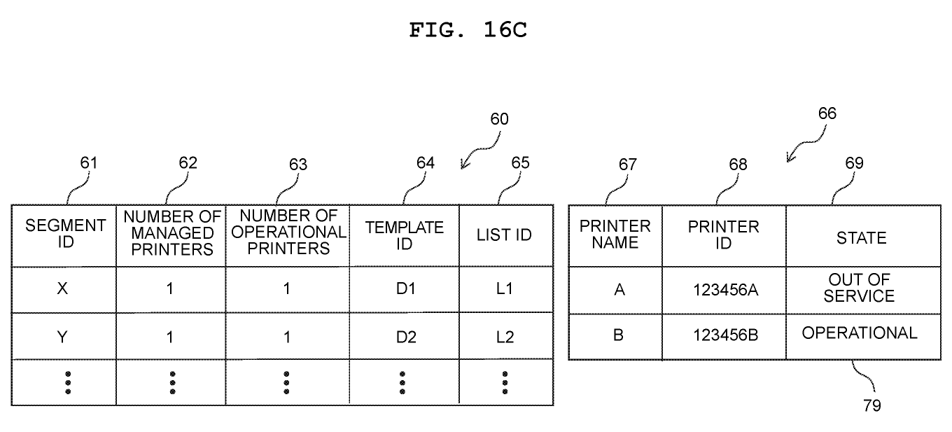

The memory 44 stores the table 60 and the table 66 of FIG. 16A, based on the data registration request. The table 60 stores a segment ID 61, a number of managed printers 62, a number of operational printers 63, a template ID 64, and a list ID 65, in association with one another.

The table 66 is a table set for each of the segments. The table 66 stores the information on the printer(s) 1 belonging to a segment X indicated by a segment ID "X". The table 66 includes a printer name 67, a printer ID 68, and a status 69. The status 69 is set to "operational" or "out of service", based on the status data transmitted from the printer 1. The status 69 is used in a process of counting the number of operational printers. The CPU 41 causes the memory 44 to store the template data corresponding to the printer 1 for each of the management addresses, in accordance with the table 60. After step S82, the CPU 41 returns the process to step S81.

In a case where the CPU 41 determines that the CPU 41 has not received the data registration request (step S81: NO), the CPU 41 determines whether the management server 4 has been accessed by the printer 1 (step S83). In a case where the CPU 41 determines that the management server 4 has not been accessed by the printer 1 (step S83: NO), the CPU 41 determines whether a printing completion notice has been received from the printer 1 via the communication part 45 (step S90). In a case where the CPU 41 determines that the CPU 41 has received the printing completion notice (step S90: YES), the CPU 41 causes the memory 44 to store the printing completion notice, while associating the printing completion notice with the printer ID of the printer 1 which has transmitted the printing completion notice (step S91). After step S91, the CPU 41 returns the process to step S81.

In a case where the CPU 41 determines that the CPU 41 has not received the printing completion notice (step S90: NO), the CPU 41 determines whether the CPU 41 has received a printing incompletion notice from the printer 1 via the communication part 45 (step S92). In a case where the CPU 41 determines that the CPU 41 has received the printing incompletion notice (step S92: YES), the CPU 41 causes the memory 44 to store the printing incompletion notice, while associating the printing incompletion notice with the printer ID of the printer 1 which has transmitted the printing incompletion notice (step S93). After step S93, the CPU 41 returns the process to step S81. The CPU 41 may cause the memory 44 to store the printing completion notice and the printing incompletion notice, as data representing the print history of the printer 1.

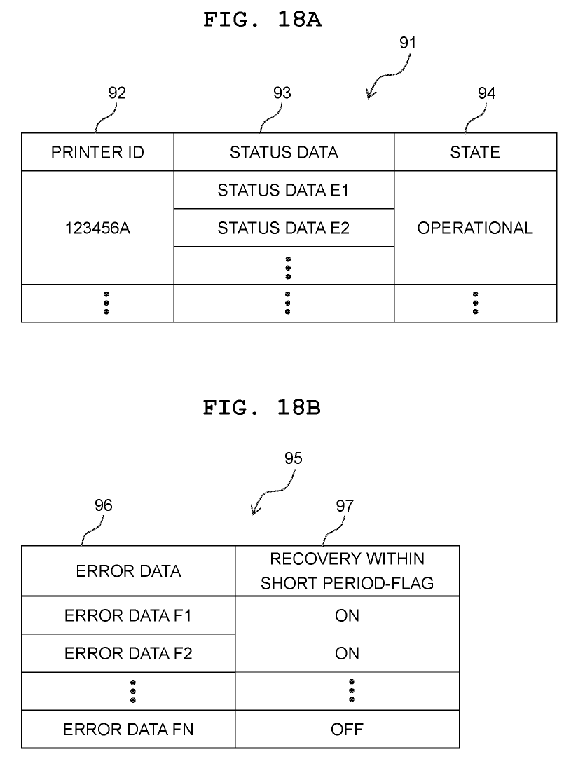

In a case where the CPU 41 determines that the CPU 41 has not received the printing incompletion notice (step S92: NO), the CPU 41 determines whether the CPU 41 has received status data from the printer 1 via the communication part 45 (step S94). In a case where the CPU 41 determines that the CPU 41 has received the status data (step S94: YES), the CPU 41 causes the memory 44 to store the status data, while associating the status data with the printer ID (step S95). As illustrated in FIG. 18A, the memory 44 stores a table 91. The table 91 stores a printer ID 92, status data 93, and a state 94, in association with one another.

The printer ID 92 is the printer ID of each of the managed printers. The status data 93 is data indicating the status transmitted from each of the printers 1. The status data 93 is stored in the table 91 in the order of receipt from the printers 1 and with respect to each of the printers 1. The status data is used, for example, to manage the print history of each of the managed printers.

The state 94 is the status of the printer 1 identified based on the latest status data. The state 94 in the present embodiment has the same value as the value of the state 69 in the table 66, and is indicated as "operational" or "out of service". In a case where the state 94 is changed from "operational" to "out of service", the CPU 41 reduces the number of operational printers associated with the segment ID by 1 (one), and changes the state 94 from "operational" to "out of service".

The CPU 41 transmits the status data to the maintenance server 5 via the communication part 45 (step S96). In a case where the CPU 41 determines that the CPU 41 has not received the status data (step S94: NO), or after the process of step S96, the CPU 41 returns the process to step S81.

In a case where the CPU 41 determines that the management server 4 has been accessed by the printer A in Example 2 (step S83: YES), the CPU 41 determines whether the printer A has successfully accessed the management server 4 (step S84). In a case where the CPU 41 determines that the printer A has failed to access the management server 4 (step S84: NO), the CPU 41 performs the process of step S85. The CPU 41 transmits, via the communication part 45, error data indicating an access error to the printer 1 which has unsuccessfully accessed the management server 4 (step S85). The CPU 41 returns the process to step S81.

In a case where the CPU 41 determines that the printer A has successfully accessed the management server 4 (step S84: YES), the CPU 41 performs the process of step S86. The CPU 41 determines whether the CPU 41 has received an obtainment request via the communication part 45 from the printer A successfully accessed the maintenance server 4 in step S84 (step S86). In a case where the CPU 41 determines that the CPU 41 has received the obtainment request from the printer A (step S86: YES), the CPU 41 performs an obtainment requesting process (step S87).

As illustrated in FIG. 15, in the obtainment requesting process, the CPU 41 determines whether the number of operational printers in the segment corresponding to the printer A in Specific Example 2 is equal to or less than the number of managed printers (step S151). The segment to which the printer A belongs is the segment X indicated by the segment ID "X" associated with the printer ID of the printer A.

In a case where the CPU 41 determines that the number of operating printers exceeds the number of managed printers (step S151: NO), the CPU 41 identifies a backup printer from among the printers in operation in the segment to which the printer 1 belongs (step S152). The backup printer is a printer 1 which is not a printer 1 as a target to be managed by the management server 4, but is a candidate for a target to be managed by the management server 4. The CPU 41 identifies the backup printer from among the operational printers 1 so that the number of operational printers in the segment, to which the printers 1 belong, equals the number of managed printers.

The CPU 41 in the present embodiment identifies a backup printer in, for example, ascending order of priority of the printers 1. The priority may be set as appropriate. The priority may be set by the owner, administrator, or user of the printer 1. The priority may be set automatically in accordance with the model number, the number of years of use, the amount of use, etc., of the printer 1.

The CPU 41 transmits, via the communication part 45, a change instruction to the backup printer identified in step S152 (step S153). The change instruction instructs the printer 1 to set the maintenance server 5 as the next connection address.

The CPU 41 determines whether the printer A has been identified as a backup printer in step S152 (step S154). In a case where the CPU 41 determines that printer 1 has been identified as the backup printer (step S154: YES), the CPU 41 ends the obtainment requesting process, and the CPU 41 returns the process to the management server process. In a case where the CPU 41 determines that the printer A has not been identified as the backup printer (step S154: NO), the CPU 41 performs a process of step S155.

In Specific Example 2, the CPU 41 refers to the table 60 of FIG. 16A, and determines that the number of operational printers is equal to or less than the number of managed printers (step S151: YES). The CPU 41 determines whether updated data is included in the data corresponding to the printer ID of the printer A (step S155). The data corresponding to the printer ID of the printer A includes the template data associated with the printer ID of the printer A and the print content data list associated with the printer ID of the printer A. The CPU 41 determines that the updated data exists in a case where the data has been updated since the previous transmission of data in step S159 or step S161.

In a case where the CPU 41 determines that the updated data is included (step S155: YES), the CPU 41 determines whether the printer A is capable of performing printing using the template data (step S158). The CPU 41 may determine whether the printer A is capable of performing printing using the template data, based on data previously registered with the memory 44 or the data included in the obtainment request. For example, the CPU 41 may determine whether the printer A is capable of performing printing using the template data, based on the model number of the printer 1.

The CPU 41 determines that the printer A is capable of performing the template printing (step S158: YES). The CPU 41 transmits the following data to the printer A via the communication part 45 (step S159). In the process of step S159, the CPU 41 transmits, via the communication part 45, predetermined template data to the printer A. The predetermined template data is data included in the multiple template data stored in the memory 44 and corresponding to the printer 1.

The CPU 41 in the present embodiment transmits, to the printer A, data including the template data and the print content data list associated with the printer ID of the printer A, and a transition instruction. The template data associated with the printer ID of the printer A is template data identified by a template ID "D1". The print content data list associated with the printer ID of the printer A is print content data list identified by a list ID "L1". The transition instruction instructs that the print mode of the printer 1 is to transition to the template print mode.

In a case where the CPU 41 determines that the printer 1 is not capable of performing printing using the template data (step S158: NO), the CPU 41 performs a process of step S161. The CPU 41 transmits the updated image data to the printer 1 via the communication part 45 (step S161). After the process of step S157, step S159, or step S161, the CPU 41 ends the obtainment requesting process, and returns the process to the management server process.

In a case where the CPU 41 determines that the update data does not exist (step S155: NO), the CPU 41 determines whether the printer 1 is capable of performing printing using the template data (step S156). In a case where the CPU 41 determines that the printer 1 is capable of performing template printing (step S156: YES), the CPU 41 transmits the transition instruction to the printer 1 via the communication part 45 (step S157). In a case where the CPU 41 determines that the printer 1 is not capable of performing template printing (step S156: NO), or after the process of step S157, the CPU 41 ends the obtainment requesting process, and returns the process to the management server process. The CPI 41 returns the process to S81 after the process of step S87.

Regarding the above-described obtainment requesting process, a case where the template data and the print content data list are each associated with the printer ID is described. The printer ID may not be associated with the print content data list. In this case, in step S159, the CPU 11 may transmit the updated template data and the transition instruction to the printer 1 via the communication part 45.

In a case where the CPU 41 determines that the CPU 41 has not received the obtainment request from the printer 1 (step S86: NO), the CPU 41 performs a process of step S88. The CPU 41 determines whether the CPU 41 has received, via the communication part 45, the registration request from the printer 1 successfully accessed the management server 4 in step S84 (step S88). In a case where the CPU 41 determines that the CPU 41 has not received the registration request from the printer 1 (step S88: NO), the CPU 41 returns the process to step S81. In a case where the CPU 41 determines that the CPU 41 has received the registration request from the printer 1 (step S88: YES), the CPU 41 performs a registration requesting process (step S89).

In a case where the CPU 41 determines that the CPU 41 has obtained the status data from the printer A indicating that the printer A is out of service (step S94: YES), the CPU 41 stores the status data in the table 91 (step S95). The CPU 41 changes the state 94 corresponding to the printer A in the table 91 from "operational" to "out of service", based on the status data. As illustrated in FIG. 16B, the CPU 41 decreases, by one, the number of operational printers 63 corresponding to the segment ID "X" indicating the segment X to which the printer A belongs, in the table 60, based on the status data. The CPU 41 changes the state 69 corresponding to the printer A from "operational" to "out of service" in the table 66, based on the status data. The CPU 41 returns the process to step S81, after the process of step S89. The CPU 41 ends the management server process in a case where the power of the management server 4 is turned off.

The management server process corresponding to a case where the printer A in Specific Example 1 accesses the management server 4 will be described, with reference to FIGS. 3A, 6, 14A and 14B, 16A and 17A and 17B. In a case where the CPU 41 determines that the printer A in Specific Example 1 accesses the management server 4 (step S83: YES; step S84: YES), the CPU 41 determines that the CPU 41 has received the registration request from the printer A (step S88: YES), and performs the registration requesting process (step S89).

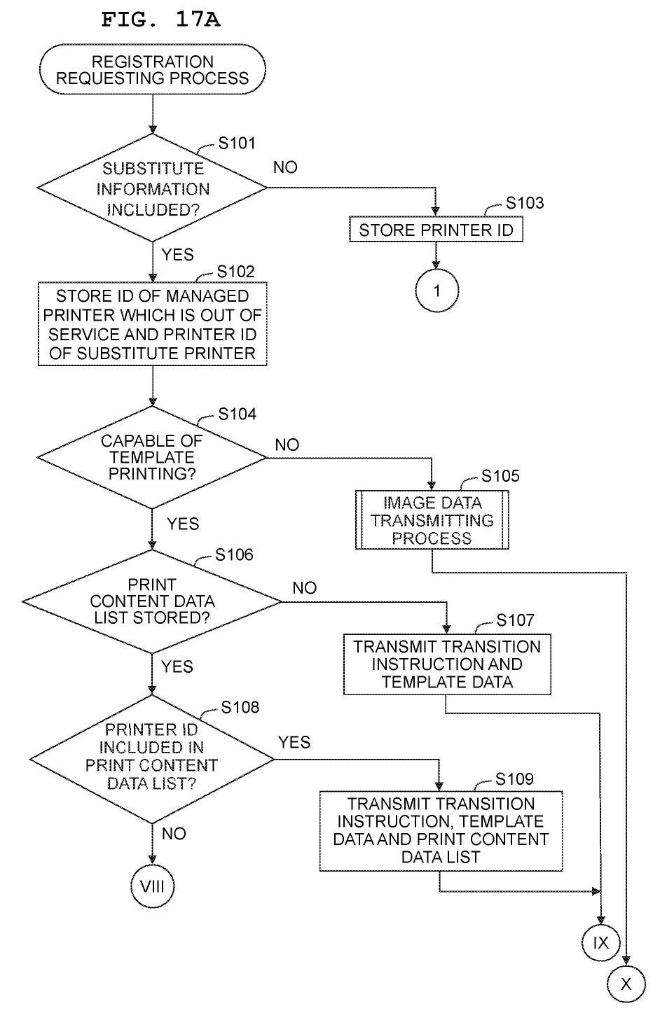

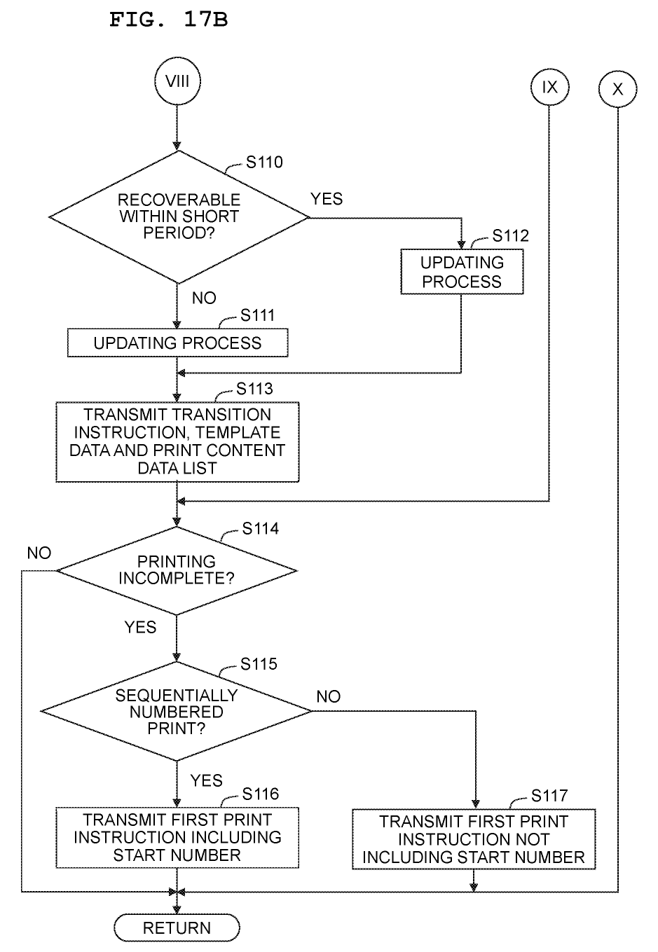

As illustrated in FIGS. 17A and 17B, in the registration requesting process, the CPU 41 determines whether the registration request includes the substitute information (step S101). The CPU 41 determines that the registration request received from the printer A does not include the substitute information (step S101: NO). The CPU 41 causes the memory 44 to store the printer ID of the printer 1, as illustrated in the table 66 of FIG. 16A (step S103). The CPU 41 performs the process of step S151 and steps after step S151 of the obtainment requesting process illustrated in FIG. 15. In step S155 corresponding to a case where the CPU 41 determines that the CPU 41 has received the registration request, the CPU 41 determines that the update data is included, and perform the process (step S155: YES).

The management server process corresponding to a case where the printer B in Specific Example 3 accesses the management server 4 will be described, with reference to FIGS. 4A, 10, 14A and 14B, and 17A and 17B. In a case where the CPU 41 determines that the printer B in Specific Example 3 accesses the management server 4 (step S83: YES; step S84: YES), the CPU 41 determines that the CPU 41 has received the registration request from the printer B (step S88: YES), and performs the registration requesting process (step S89).

The CPU 41 determines that the registration request received from the printer B includes the substitute information (step S101: YES). The registration request corresponding to a case where the printer 1 is a substitute printer includes the printer-related information, the status data, and the substitute information. The CPU 41 causes the memory 44 to store the printer ID of the printer A indicated by the substitute information, and the printer ID of the printer B indicated by the printer-related information, in association with each other (step S102).

Specifically, as illustrated in FIG. 16C, the CPU 41 adds data 79 of the printer B to the table 66 in which the information on the printer 1 belonging to the segment X is stored. The table 66 is a table in which the printer ID of the printer A is associated with the printer ID of the printer B. In response to the addition of the data 79 to the table 66, the CPU 41 increases, by one, the number of operational printers 63 corresponding to the segment ID "X", in table 60, which indicates the segment X to which the printer B belongs.

The CPU 41 determines whether the printer B is a printer capable of performing the template printing (step S104). In a case where the CPU 41 determines that the printer B is a printer capable of performing the template printing (step S104: YES), the CPU 41 determines whether the print content data list corresponding to the printer B is stored in the memory 44 (step S106). The CPU 41 determines that the print content data list corresponding to the printer B is stored in the memory 44, in a case where the list ID associated with the segment ID of the segment X to which the printer B belongs is stored in the table 60.

The CPU 41 performs a process of step S107 in a case where the CPU 41 determines that the print content data list corresponding to the printer 1 is not stored in the memory 44 (step S106: NO). The CPU 41 transmits the transition instruction, and the template data corresponding to the printer 1, to the printer 1 via the communication part 45 (step S107). The CPU 41 performs a process of step S114.

In a case where the CPU 41 determines that the print content data list corresponding to the printer B is stored in the memory 44 (step S106: YES), the CPU 41 performs the process of step S108. The CPU 41 determines whether the printer ID is stored in the print content data list (step S108). In a case where the printer 1 which has accessed the management server 4 is a substitute printer, the printer ID is usually not stored in the print content data list. Even in a case where the printer 1 which has accessed the management server 4 is the substitute printer, the printer ID of the substitute printer is stored in the print content data list by the process of step S111 or step S112, in some cases.

In a case where the CPU 41 determines that the printer ID is stored in the print content data list (step S108: YES), the CPU 41 performs a process of step S109. The CPU 41 transmits the transition instruction, the template data and the print content data list corresponding to the printer 1, to the printer 1 via the communication part 45 (step S109). The CPU 41 performs a process of step S114.

In a case where the CPU 41 determines that the printer ID is not stored in the print content data list (step S108: NO), the CPU 41 performs a process of updating the print content data list L1. Specifically, the CPU 41 determines whether the kind of error indicated by the status data of another printer 1, which is different from the printer 1 performing the process, is an error classified as being recoverable within a short period (step S110).

As illustrated in FIG. 18B, the memory 44 stores a table 95 indicating whether the error is recoverable within a short period, for each kind of error. The table 95 stores error data 96, and a recovery within short period-flag 97, in association with each other. The length of the short period may be set appropriately, e.g., within one day.

In a case where the recovery within short period-flag 97 is ON, the kind of error indicated by the error data 96 is classified as being recoverable within the short period. In a case where the recovery within short period-flag 97 is OFF, the kind of error indicated by the error data 96 is not classified as being recoverable within the short period. The recovery within short period-flag 97 may be set in advance or may be set by the owner, administrator, or user of the printer 1.

For example, the recovery within short period-flag 97 corresponding to abnormality in the placement of the print medium 3, jamming of the print medium 3, shortage of the print medium 3, and abnormal temperature of the print head 26 is set to ON. The recovery within short period-flag 97 corresponding to a malfunction of the motor 22, and a malfunction of the sensor 27 is set to OFF. The CPU 41 identifies the recovery within short period-flag 97 regarding the error data associated with the printer ID of another printer 1 different from the printer 1 which has accessed the management server 4. Based on the identified recovery within short period-flag 97, the CPU 41 determines whether the kind of error indicated by the error data 96 is classified as being the kind of error recoverable within the short period.

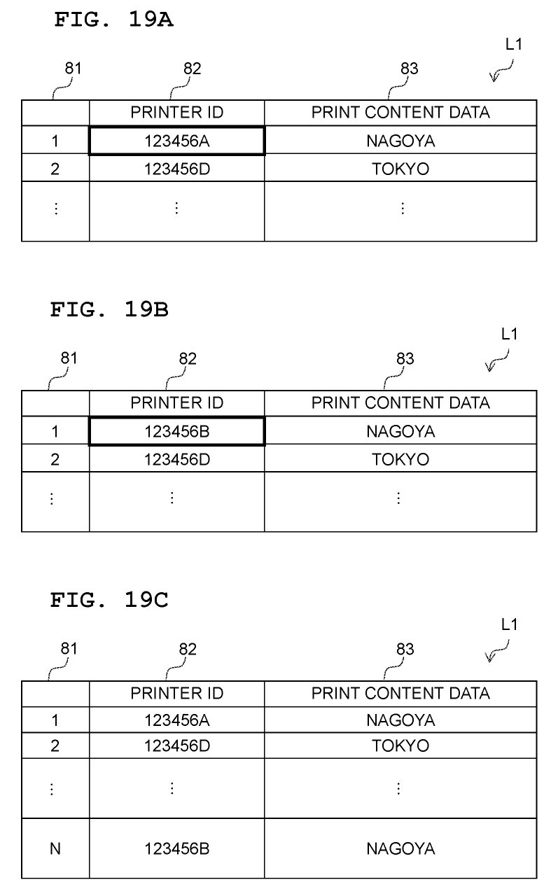

In a case where the CPU 41 determines that the kind of error indicated by the error data is the error classified as being recoverable within the short period (step S110: YES), the CPU 41 updates the print content data list L1 (step S112). Specifically, the CPU 41 adds the updated data to the print content data list L1 illustrated in FIG. 19A. The updated data is the data in which the printer ID of the printer B is associated with the print content data associated with the printer A. As illustrated in FIG. 19C, the CPU 41 adds data, of which data number 81 is indicated by "N", to the print content data list L1 (step S112).

In a case where the CPU 41 determines that the kind of error indicated by the error data is not an error classified as being recoverable within the short period (step S110: NO), the CPU 41 updates the print content data list L1 (step S111). As illustrated in FIG. 19B, the CPU 41 replaces the printer ID of the printer A with the printer ID of the printer B, in data of which data number 81 is "1".

After step S111 or step S112, the CPU 41 transmits the print content data list L1, the template data, and the transition instruction to the printer B via the communication part 45 (step S113). The template data is the template corresponding to the print content data list L1.

The CPU 41 determines whether an uncompleted print instruction exists in the managed printer, based on the error data associated with the another printer A indicated by the substitute information (step S114). For example, the CPU 41 refers to the table 91 illustrated in FIG. 18A, and determines that the uncompleted print instruction exists, in the following case. That is, for example, in a case where a number of sheets, on which the printing is to be performed, indicated by the print instruction included in the error data associated with the another printer 1 different from the printer 1 which has accessed the management server 4 is greater than a number of sheets on which the printing has been completed.

In a case where the CPU 41 determines that the uncompleted print instruction does not exist (step S114: NO), the CPU 41 ends the registration requesting process, and returns the process to the management server process. In a case where the CPU 41 determines that the uncompleted print instruction exists (step S114: YES), the CPU 41 determines whether the uncompleted print instruction instructs to perform printing of a print image including sequentially numbered print contents (step S115). In a case where the CPU 41 determines that the uncompleted print instruction instructs to perform printing of the print image including the sequentially numbered print contents (step S115: YES), the CPU 41 performs a process of step S116.

The CPU 41 transmits the first print instruction including a start number and an end number to the printer 1 via the communication part 45 (step S116). The start number is set, for example, to a number which is next to the last number assigned to the printing on the print medium 3 already performed by another printer 1. The printer 1 used as a substitute printer does not print the print image which has already been printed in the managed printer, based on the first print instruction. The printer 1 used as the substitute printer is capable of completing the print instruction uncompleted in the managed printer, based on the first print instruction.

In a case where the CPU 41 determines that the uncompleted print instruction does not instruct to perform printing of the print image including the sequentially numbered print contents (step S115: NO), the CPU 41 performs a process of step S117. The CPU 41 transmits the first print instruction not including the start number and the last number to the printer 1 via the communication part 45 (step S117). After the process of step S116 or step S117, the CPU 41 ends the registration requesting process, and returns the process to the management server process.

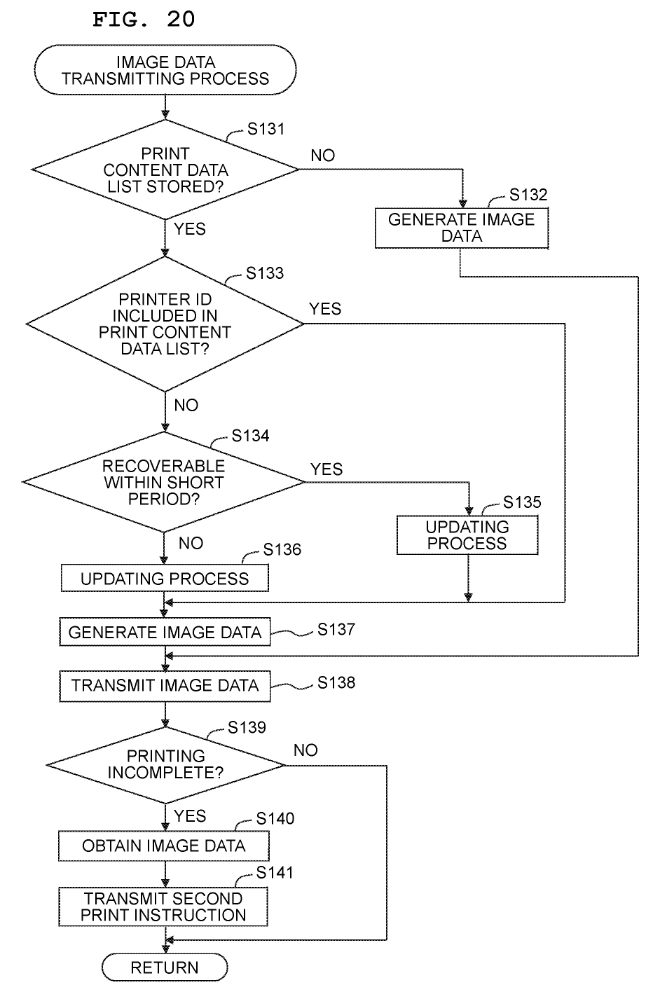

In a case where the CPU 41 determines that the printer 1 is not capable of performing the template printing (step S104: NO), the CPU 41 performs an image data transmitting process (step S105). As illustrated in FIG. 20, in the image data transmitting process, the CPU 41 determines whether the print content data list associated with the printer ID of the printer 1 is stored in the memory 44 (step S131).

In a case where the CPU 41 determines that the print content data list associated with the printer 1 ID is not stored in the memory 44 (step S131: NO), the CPU 41 performs a process of step S132. The CPU 41 generates image data indicating a print image based on the template data (step S132). The print image based on the template data is an image in which the print content is applied to the layout indicated by the template data. The CPU 41 performs a process of step S138.

In a case where the CPU 41 determines that the print content data list associated with the first printer ID is stored in the memory 44 (step S131: YES), the CPU 41 performs a process of step S133. The CPU 41 determines whether the printer ID is stored in the print content data list (step S133). In a case where the CPU 41 determines that the first printer ID is stored in the print content data list (step S133: YES), the CPU 41 performs a process of step S137. The CPU 41 generates image data indicating the print image in which the print content data associated with the first printer ID is applied to the layout indicated by the template data (step S137).

In a case where the CPU 41 determines that the first printer ID is not stored in the print content data list (step S133: NO), the CPU 41 performs a process of updating the print content data list L1. Specifically, the CPU 41 determines whether the kind of error indicated by the error data in the status data of the printer A, which another printer different from the printer B, is an error classified as being recoverable within the short period (step S134).

In a case where the CPU 41 determines that the kind of error indicated by the error data is an error classified as being recoverable within the short period (step S134: YES), the CPU 41 performs the process of step S135 in a similar manner to step S112. In a case where the CPU 41 determines that the kind of error indicated by the error data is not an error classified as being recoverable within the short period (step S134: NO), the CPU 41 updates the print content data list L1 (step S136), in a similar manner to step S111.

After step S136 or step S135, the CPU 41 generates image data indicating a predetermined print image (step S137). The predetermined print image is an image in which the print content data associated with the printer ID is applied to the layout indicated by the template data. The CPU 41 transmits, via the communication part 45, the image data to the printer 1 which has accessed the management server 4 (step S138).

The CPU 41 determines whether an uncompleted print instruction exists in the managed printer, based on the error data associated with the managed printer (step S139). In a case where the CPU 41 determines that an uncompleted print instruction exists in the managed printer (step S139: YES), the CPU 41 obtains image data for completing the uncompleted print instruction (step S140). The CPU 41 obtains the image data included in the printing incompletion information received from printer 1 via the communication part 45.

The CPU 41 transmits the second print instruction including the image data to the printer 1 via the communication part 45. In a case where the CPU 41 determines that any uncompleted print instruction does not exist in the managed printer (step S139: NO), or after the process of step S141, the CPU 41 ends the image data transmitting process, and the CPU 41 returns the process to the registration requesting process. After the process of step S105, the CPU 41 ends the registration requesting process, and the CPU 41 returns the process to the printer process.

The management address of the printer system 7 of a first modification will be described. The management address of the printer system 7 of the first modification is as follows. The management address, corresponding to a case where no print content data list corresponding to the template data is stored, includes a URL indicating the storage location, in the management server 4, in which the template data is stored. The CPU 51 of the maintenance server 5 of the printer system 7 in the first modification causes the memory 54 to store the management address including the URL in the address storing process (step S62). The URL in the first modification indicates the storage location, in the management server 4, in which the template data is stored.

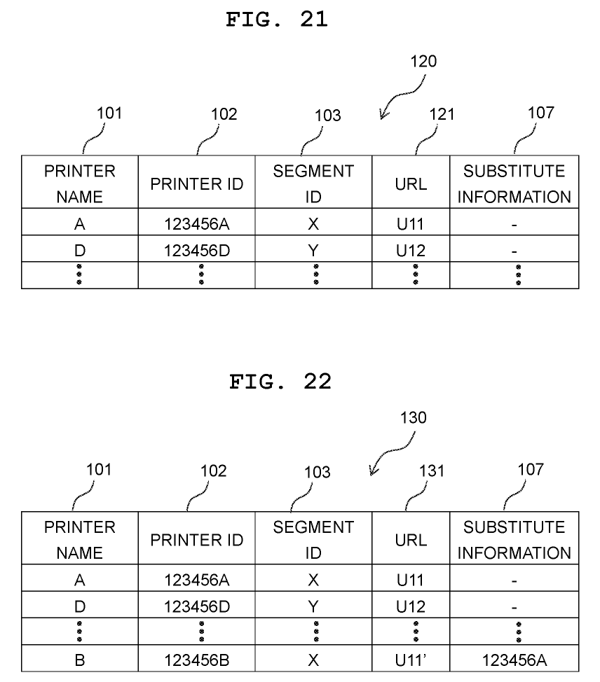

As illustrated in FIG. 21, the memory 54 of maintenance server 5 in the first modification stores a table 120. The CPU 51 registers data with the table 120 in accordance with the registration request. In the table 120, the same reference numerals are affixed to the items which are similar to the items in the table 100. The table 120 stores a printer name 101, a printer ID 102, a segment ID 103, URL 121, and substitute information 107, in association with one another. The table 120 in the first modification does not include the template ID and the list ID.

The CPU 11 of the printer 1 of the printer system 7 in the first modification receives, in the first receiving process, the management address including the URL in the first modification, via the communication part 21 (step S8). In the second receiving process, the CPU 11 accesses the storage location indicated by the URL, and receives the template data via the communication part 21 (step S18, step S34, step S182).

The management address, corresponding to a case where the print content data list corresponding to the template data is stored, includes a predetermined URL. The predetermined URL indicates a storage location, in the management server 4, in which the template data and the print content data list are stored. The CPU 51 of the maintenance server 5 of the printer system 7 in the first modification causes the memory 54 to store the management address including the URL in the address storing process (step S62).

The CPU 11 of the printer 1 of the printer system 7 in the first modification accesses the storage location indicated by the URL, and receives the predetermined data via the communication part 21 in the second receiving process (step S18, step S34, step S182). The predetermined data includes template data corresponding to the printer 1 and the print content data list corresponding to the template data.

A management address of the printer system 7 in a second modification will be described. The management address of the printer system 7 in the second modification differs between a case where the printer 1 is a managed printer and in a case where the printer 1 is a substitute printer.

In the address storing process, the CPU 51 of the maintenance server 5 of the printer system 7 in the second modification causes the memory 54 to store the management address corresponding to a case where printer 1 is the substitute printer (step S62). As illustrated in FIG. 22, the memory 54 of the maintenance server 5 in the second modification stores a table 130, rather than the table 100. The CPU 51 registers data with the table 130, in accordance with the registration request. In table 130, the same reference numerals are affixed to the items which are similar to the items in the table 100.

The table 130 stores a printer name 101, a printer ID 102, a segment ID 103, a URL 131, and substitute information 107, in association with one another. The table 130 in the second modification does not include the template ID and the list ID. The printer A and the printer B are associated with the same segment ID. A URL corresponding to the printer A is "U11", which is different from a URL "U11´" corresponding to the printer B. The URL "U11´" corresponding to the printer B may be obtained by adding, to the end of the URL "U11" corresponding to the printer A, with substitute information (which is "'" in the example). In this case, even in a case where the maintenance server 5 does not transmit the management address and the substitute information to the printer B or the management server 4, the management server 4 is able to recognize that the printer B is a substitute printer for the printer A, in a case where the maintenance server 5 transmits the management address to the management server 4 or the printer B.

In the management address transmitting process, the CPU 51 transmits, to the printer 1, the management address corresponding to a case where the printer 1 is the substitute printer and the management address corresponding to a case where the printer 1 is not the substitute printer, the former management address and the latter management address being different from each other. The management address corresponding to the case where the printer 1 is the substitute printer may differ from the management address corresponding to the case where the printer 1 is not the substitute printer, in view of having mutually different subdirectory hierarchy. The depth of the subdirectory indicated by the management address corresponding to the case where printer 1 is the substitute printer may be deeper than the depth of the subdirectory indicated by the management address corresponding to the case where printer 1 is the managed printer.

In the printer system 7 in the second modification, the CPU 11 of the printer B in Specific Example 3 receives, in the first receiving process, the management address via the communication part 21 (step S8). The management address in step S8 is the address corresponding to a case where the printer B is a substitute printer to be used as a substitute for another printer A which is different from the printer B. The CPU 11 accesses the management server 4 using the management address in the second receiving process. The CPU 11 receives the template data corresponding to the printer A different from the printer B which performs the process, via the communication part 21 (step S182).

The printer-related information of the printer system 7 in a third modification will be described. The printer-related information of the printer system 7 in the third modification is a segment ID for identifying the segment to which the printer 1 belongs.

The CPU 51 of the maintenance server 5 of the printer system 7 in the third modification causes the memory 54 to store the segment ID and the management address, in association with each other, in the address storing process (step S62). The CPU 51 receives the segment ID from the printer 1 (step S69). In the management address transmitting process, the CPU 54 transmits a predetermined management address from among the plurality of management addresses stored in the memory 54 (step S72, S73). The predetermined management address is the management address associated with the segment ID transmitted from the printer 1.

In the first transmitting process, the CPU 11 of the printer 1 of the printer system 7 in the third modification transmits the segment ID to the maintenance server 5 via the communication part 21 (step S3). The segment ID may be input via the input part 23 by the owner, administrator or user of the printer 1, and may be stored in the memory 14, before the CPU 11 performs the printer process. The segment ID may be input by the owner, administrator, or user of the printer 1 via the input part 23 and may be stored in the memory 14 while the CPU 11 is performing the printer process. In the first receiving process, the CPU 11 receives, via the communication part 21, the management address associated with the segment ID from the maintenance server 5 (step S8).

In the print content data list in the third modification, the print content data may be associated with the segment ID. In this case, the CPU 41 of the management server 4 may omit the processes of step S110 to step S112 of FIG. 17B and processes of step S134 to step S136 of FIG. 20.

The print content data-related information of the printer system 7 in a fourth modification will be described. The print content data-related information in the fourth modification is the print content data. In a case where the CPU 11 of the printer 1 of the printer system 7 in the fourth modification obtains the first print instruction including the template ID and the print content data in the print instruction obtaining process, the CPU 11 performs the printing process. In the printing process, the CPU 11 causes the print head 26 to print a print image in which a print content indicated by the print content data included in the first print instruction is applied to a layout indicated by the template data. The print image is an image in which the print content indicated by the print content data is applied to the layout indicated by the template data.

The printer-related information of the printer system 7 in a fifth modification will be described. The printer-related information of the printer system 7 in the fifth modification is a user ID for identifying the owner, owning corporation, administrator, administrating corporation, user, or using corporation of the printer 1. The user ID is set in the management server 4 or the maintenance server 5 in a case where, for example, the owner, administrator, or user, etc., of the printer 1 registers the printer 1 with the printer system 7. The user ID may be input via the input part 23 by the owner, administrator, or user of the printer 1 and may be stored in the memory 14, before the printer 1 performs the printer process.

The CPU 51 of the maintenance server 5 of the printer system 7 in the fifth modification causes the memory 54 to store the user ID and the management address, in association with each other, in the address storing process (step S62). The CPU 51 receives the user ID from the printer 1 (step S69). In the management address transmitting process, the CPU 51 transmits a predetermined management address from among the plurality of management addresses stored in the memory 54 (step S72, step S73). The predetermined management address is a management address associated with the user ID transmitted from the printer 1.

The CPU 11 of the printer 1 of the printer system 7 in the fifth modification transmits the user ID to the maintenance server 5 via the communication part 21 in the first transmitting process (step S3). The CPU 11 receives the management address associated with the user ID from the maintenance server 5 via the communication part 21 in the first receiving process (step S8).

In the print content data list in the fifth modification, the print content data may be associated with the user ID. In this case, the CPU 41 of the management server 4 may omit the processes of steps S110 to S112 of FIG. 17B, and the processes of steps S134 to S136 of FIG. 20.

In the above-described embodiment, the printer 1 is an example of a "printer" of the present disclosure. The management server 4 is an example of a "management server" of the present disclosure. The maintenance server 5 is an example of a "maintenance server" of the present disclosure. The printer system 7 is an example of a "printer system" of the present disclosure. The CPU 11 is an example of a "processor" of the present disclosure. The memory 14 is an example of a "memory" of the present disclosure. The communication part 21 is an example of a "communication interface" of the present disclosure. The print head 26 is an example of a "printing mechanism" of the present disclosure. The CPU 41 is an example of a "management server processor" of the present disclosure. The memory 44 is an example of a "management server memory" of the present disclosure. The communication part 45 is an example of a "management server communication interface" of the present disclosure. The CPU 51 is an example of a "maintenance server processor" of the present disclosure. The memory 54 is an example of a "maintenance server memory" of the present disclosure. The communication part 55 is an example of a "maintenance server communication part" of the present disclosure.

The processes of steps S3 and S7 are an example of a "first transmitting process" of the present disclosure. The process of step S8 is an example of a "first receiving process" of the present disclosure. The process of each of step S18, step S34, and step S182 is an example of a "second receiving process" of the present disclosure. The process of each of step S186 and step S51 is an example of a "print instruction obtaining process" of the present disclosure. The process of each of step S187 and step S52 is an example of a "printing process" of the present disclosure. The process of step S8 is an example of a "substitute information obtaining process" of the present disclosure. The process of step S181 is an example of a "substitute information transmitting process" of the present disclosure. The process of each of step S9 and step S43 is an example of a "setting process" of the present disclosure. The process of step S2 is an example of an "outputting process" of the present disclosure. The process of step S5 is an example of a "message outputting process" of the present disclosure. The process of each of step S18, step S34, and step S182 is an example of a "mode transition instruction receiving process" of the present disclosure. The process of each of step S21, step S37, and step S185 is an example of a "mode transitioning process" of the present disclosure.

The process of step S62 is an example of an "address storing process" of the present disclosure. The process of step S65 is an example of a "related information receiving process" of the present disclosure. The process of each of step S72 and step S73 is an example of a "management address transmitting process" of the present disclosure. The process of step S62 is an example of a "substitute information storing process" of the present disclosure. The process of step S73 is an example of a "substitute information transmitting process" of the present disclosure. The process of step S74 is an example of a "first error transmitting process" of the present disclosure. The process of step S68 is an example of a "second error transmitting process" of the present disclosure. The process of step S82 is an example of a "template storing process" of the present disclosure. The process of each of step S159, step S107, step S109, and step S113 is an example of a "template transmitting process" of the present disclosure.

The printer system 7 in the above-described embodiment includes the printer 1, the maintenance server 5, and the management server 4. The printer 1 includes: the memory 14 configured to store the maintenance address, which is the address of the maintenance server 5; the print head 26; the communication part 21; and the CPU 11. The printer control program is performed by the CPU 11 of the printer 1. The printer control program includes the instructions for causing the CPU 11 to perform the first transmitting process, the first receiving process, the second receiving process, the print instruction obtaining process, and the printing process. The CPU is configured to be capable of performing the first transmitting process, the first receiving process, the second receiving process, the print instruction obtaining process, and the printing process. The first transmitting process is the process of accessing the maintenance server 5 using the maintenance address and of transmitting the printer-related information related to the printer 1 to the maintenance server 5 via the communication part 21 (step S3, step S7). The first receiving process is the process of receiving the management address from the maintenance server 5 via the communication part 21, in accordance with the first transmitting process (step S8). The management address indicates the source from which the template data corresponding to the printer-related information is obtainable. The template data is data for printing a predetermined print content based on a predetermined layout. The second receiving process is the process of accessing the management server 4, which is the same as or different from the maintenance server 5, using the management address and of receiving the template data corresponding to the printer, via the communication part 21 (step S18, step S34, step S182). The print instruction obtaining process is the process of obtaining the first print instruction or the second print instruction (step S51, step S186). The first print instruction includes the template ID for identifying the template data, and the print content data-related information related to the print content data indicating the print content. The second print instruction includes the image data indicating a print image based on the print content data and template data. The printing process is the process of causing the print head 26 to print the print image (step S52, step S187). The print image corresponding to a case where the first print instruction is obtained is an image in which the print content is applied to the layout indicated by the template data associated with the template ID. The print content is identified based on the first print instruction. The print image corresponding to a case where the second print instruction is obtained is an image indicated by the image data based on the second print instruction.

The first receiving process and the second receiving process of the printer 1 contribute to receiving the template corresponding to the printer 1 from the management server 4. In a case where the template data corresponding to the printer 1 needs to be set for each of the plurality of printers 1, the administrator sets the management address. The management address is the address which is set in the maintenance server 5 and in which the template data to be obtained by the printer 1 is stored. Thus, each of the plurality of printers 1 can access the maintenance server 5 so as to obtain the management address, and can use the management address so as to obtain the template data. Therefore, the first receiving process and the second receiving process of the printer 1 contribute to setting the template to be used for printing more easily than the known technique.

In the first receiving process, the CPU 11 receives the management address via the communication part 21 (step S8). The management address includes the URL of the management server 4 and the template ID of the template data corresponding to the printer 1. The CPU 11 receives, in the second receiving process, the template data corresponding to the printer and identified by the URL and the template ID, via the communication part 21. The first receiving process and the second receiving process of the printer 1 contribute to realizing the management address with a simple configuration including the URL of the management server 4 and the template ID.

The CPU 11 in the first modification receives, in the first receiving process, the management address including the URL indicating the storage location, in the management server 4, in which the template data is stored, via the communication part 21 (step S8). The CPU 11 accesses, in the second receiving process, the storage location indicated by the URL, and receives the template data, via the communication part 21 (step S18, step S34, step S182). The first receiving process and the second receiving process of the printer 1 contribute to realizing the management address with a simple configuration including the URL of the storage location, in the management server 4, in which the template data is stored.

In the first receiving process, the CPU 11 in the above-described embodiment receives the management address via the communication part 21 (step S8). The management address indicates the source from which the print content data list and template data are obtainable. The print content data list includes the print content data indicating the print content and the identification information for identifying the print content data. In the second receiving process, the CPU 11 receives the template data and the print content data list via the communication part 21 (step S18, step S34, step S182). The print content data-related information is the identification information. In a case where the CPU 11 obtains the first print instruction including the template ID and the identification information in the print instruction obtaining process, the CPU 11 causes the print head 26 to print a print image in the printing process (step S52, step S187). The print image is a print image in which the print content indicated by the print content data is applied to the layout indicated by the template data.

The first receiving process and the second receiving process of the printer 1 contribute to obtaining the template data and the print content data list corresponding to the printer 1 more easily than the known technique. The printer 1 contributes to printing a print image in which the print content indicated in the print content data list is applied to the layout indicated by the template data.

The print content data-related information in the fourth modification is the print content data. In a case where the CPU 11 obtains the first print instruction including the template ID and the print content data in the print instruction obtaining process, the CPU 11 performs the printing process (step S52, step S187). In the printing process, the CPU 11 causes the print head 26 to print a print image. The print image is an image in which the print content indicated by the print content data is applied to the layout indicated by the template data. The printer 1 contributes to printing a print image in which the print content indicated by the print content data included in the first print instruction is applied to the layout indicated by the template data.

In the first receiving process, the CPU 11 in the above-described embodiment receives the management address via the communication part 21 (step S8). The management address includes the URL of the management server 4, the template ID of the template data corresponding to the printer 1, and the list ID for identifying the print content data list. In the second receiving process, the CPU 11 receives, via the communication part 21, the URL or the management server 4, the template data and the printer content data list corresponding to the printer 1 (step S18, step S34, step S182). The template data is identified by the template ID. The print content data list corresponds to the template data. The print content data list is identified by the list ID. The first receiving process and the second receiving process of the printer 1 contribute to realizing the management address with a simple configuration including the URL of the management server 4, the template ID, and the list ID.

The CPU 11 in the first modification receives, in the first receiving process, the management address via the communication part 21 (step S8). The management address includes the URL indicating the storage location, in the management server 4, in which the template data and the print content data list are stored. In the second receiving process, the CPU 11 accesses the storage location indicated by the URL, and receives the predetermined data via the communication part 21 (step S18, step S34, step S182). The predetermined data includes the template data corresponding to the printer 1, and the print content data list corresponding to the template data. The first receiving process and the second receiving process of printer 1 contribute to realizing the management address with a simple configuration including the URL of the management server 4.

The printer-related information in the third modification is the segment ID for identifying the segment to which the printer 1 belongs. The CPU 11 transmits the segment ID to the maintenance server 5 via the communication part 21 in the first transmitting process. The CPU 11 receives the management address associated with the segment ID from the maintenance server 5 via the communication part 21 in the first receiving process. The first transmitting process and the first receiving process of the printer 1 contribute to obtaining the template data corresponding to the segment, to which the printer 1 belong, more easily than the known technique.

The CPU 11 in the above-described embodiment is configured to perform the substitute information obtaining process and the substitute information transmitting process. The substitute information obtaining process is the process of obtaining the substitute information indicating that the printer 1 is a substitute printer to be used as a substitute for another printer 1 which is different from the printer 1 (step S8). The substitute information transmitting process is the process of transmitting the substitute information to the management server 4 via the communication part 21 (step S181). The CPU 11 accesses the management server 4 using the management address in the second receiving process. The CPU 11 receives the template data corresponding to the another printer, indicated by the substitute information, via the communication part 21 (step S182). The substitute information obtaining process and the substitute information transmitting process of the printer 1 contribute to obtaining the template data associated with another printer 1 different from the printer 1 which performs the process, more easily than the known technique.

The printer-related information in the above-described embodiment is the first printer ID for identifying the printer 1. The CPU 11 transmits the first printer ID to the maintenance server 5 via the communication part 21 in the first transmitting process (step S3). The CPU 11 obtains the substitute information from the maintenance server 5 in the substitute information obtaining process (step S8). The substitute information obtaining process of the printer 1 contributes to saving the time and effort of setting, in the printer 1, whether the printer 1 is a substitute printer for and different from the printer 1 which performs the process. The substitute information obtaining process of the printer 1 contributes to simplifying the process of obtaining the substitute information, as compared with the known technique.

The substitute information in the above-described embodiment includes the second printer ID for identifying another printer 1 different from the printer 1 which performs the process. The substitute information obtaining process and the substitute information transmitting process of the printer 1 contribute to obtaining the template data associated with another printer 1 different from the printer 1 which performs the process, more easily than the known technique.

The CPU 11 in the second modification receives, in the first receiving process, the management address via the communication part 21 (step S8). The management address is the address corresponding to a case where the printer 1 is a substitute printer to be used as a substitute for another printer 1 different from the printer 1. The CPU 11 accesses the management server 4 using the management address in the second receiving process. The CPU 11 receives the template data, corresponding to another printer 1 different from the printer which performs the process, via the communication part 21 (step S182). The first receiving process and the second receiving process of the printer 1 contribute to setting the template data corresponding to the another printer 1 different from the printer 1 performing the process, more easily than the known technique.

In the print instruction obtaining process, the CPU 11 in the above-described embodiment receives, in a predetermined case, the first print instruction or the second print instruction from the management server 4 via the communication part 21 (step S186). The predetermined case is a case where the printing incompletion information indicating the uncompleted print job using the template data exists in another printer 1 different from the printer 1 which performs the process. In a case where the CPU 11 receives the first print instruction or the second print instruction from the management server 4, the CPU 11 performs the printing process (step S187). The process of receiving the printing incompletion information and the printing incompletion information of the printer 1 contribute to completing an uncompleted print job for the another printer 1 different from the printer 1 which performs the process, more easily than the known technique.

The CPU 11 in the above-described embodiment obtains the first print instruction in the print instruction obtaining process (step S186). The CPU 11 is configured to be capable of performing the incompletion information transmitting process. The incompletion information transmitting process is the process of transmitting the printing incompletion information to the management server 4 via the communication part 21 in a predetermined case (step S190). The predetermined case is a case where printing of a print image is interrupted in the printing process. The printing incompletion information includes the template ID and print content data-related information. The incompletion information transmitting process of the printer 1 contributes to managing the printing incompletion information of the printer 1 by the management server 4. The incompletion information transmitting process of the printer 1 contributes to facilitating the process of identifying the template ID and the print content data-related information used in the uncompleted printing.

The CPU 11 in the above-described embodiment obtains the second print instruction in the print instruction obtaining process. The CPU 11 is configured to perform the incompletion information transmitting process of transmitting the printing incompletion information to the management server 4 via the communication part 21 in a predetermined case (step S190). The predetermined case is a case where printing of a print image is interrupted in the printing process. The printing incompletion information includes the image data. The incompletion information transmitting process of the printer 1 contributes to managing the printing incompletion information of the printer 1 by the management server 4. The incompletion information transmitting process of the printer 1 contributes to facilitating the process of identifying the image data used in the incomplete printing.

The CPU 11 in the above-described embodiment is configured to be capable of performing the setting process of setting the server, to which the printer 1 is to connect next, to the maintenance server 5 or the management server 4 (step S9, step S43). In a case where the server to which the printer 1 is to connect next is the maintenance server 5 (step S1: YES), the CPU 11 performs the second receiving process via the communication part 21, after performing the first receiving process (step S8). In a case where the CPU 11 determines that the server to which the printer 1 is to connect next is the management server 4 (step S1: NO), the CPU 11 does not perform the first receiving process. The CPU 11 performs the second receiving process using the management address stored in the memory 14, via the communication part 21. The setting process of the printer 1 contributes to automatically switching whether to perform the first receiving process.

The printer-related information in the above-described embodiment is the first printer ID. The CPU 11 is configured to be capable of performing the outputting process. The outputting process is the process of outputting the first printer ID for identifying the printer 1, before performing the first transmitting process, in a case where the server to which the printer 1 is to connect next is the maintenance server 5 (step S2). In the first receiving process, the CPU 11 receives the management address, in response to the printer 1 accessing, using the maintenance address, the maintenance server 5 with which the first printer ID output in the outputting process is registered (step S8). The outputting process of the printer 1 contributes to simplifying the operation through which the owner, user or administrator of the printer 1 to obtain the first printer ID in order to register the printer 1 with the maintenance server 5.

In the above-described embodiment, the case where the management address is not stored in the memory 14 indicates that the server to which the printer 1 is to connect next is the maintenance server 5. The case where the management address is stored in the memory 14 indicates that the server to which the printer 1 is to connect next is the management server 4. In the setting process, the CPU 11 sets the server, to which the printer 1 is to connect next, to the management server 4 by causing the memory 14 to store the management address received in the first receiving process (step S9). The setting process of the printer 1 contributes to automatically switching whether the server to which the printer 1 is to connect next is the management server 4 or the maintenance server 5, depending on whether the management address is stored in the memory 14.

The CPU 11 in the above-described embodiment is configured to be capable of performing the message outputting process. The message outputting process is the process of outputting the message urging, for example, the user of the printer 1 to register the printer 1 with the maintenance server 5, in a predetermined case (step S5). The predetermined case is a case where the CPU 11 receives the first kind error data indicating that the printer is not registered with the maintenance server 5, in response to the printer 1 accessing the maintenance server 5 using the maintenance address (step S4: YES). After performing the message outputting process, the CPU 11 performs the first transmitting process again (step S3). The message outputting process of the printer 1 contributes to notifying the user of the printer 1 of the situation where the printer 1 is not registered with the maintenance server 5, and urging the user to register the printer with the maintenance server 5.

The CPU 11 in the above-described embodiment receives the second kind error data from the maintenance server 5 (step S4: NO), in response to the printer 1 accessing the maintenance server 5 using the maintenance address. The second kind error data is different from the first kind error data. In a case where the CPU 11 receives the second kind error data, the CPU 11 performs the first transmitting process again, without outputting the message notifying of the occurrence of the error (step S3). The printer 1 contributes to switching between outputting the message and automatically performing the first receiving process again, depending on the kind of error.

The CPU 11 in the above-described embodiment is configured to be capable of performing the mode transition instruction receiving process and the mode transition process. The mode transition instruction receiving process is the process of receiving the transition instruction from the management server 4 via the communication part 21 (step S18, step S34, step S182). The transition instruction is the instruction for transitioning to the template print mode in which printing is performed using the template data stored in the memory 14. The mode transition process is the process in which the CPU 11 transitions to the template print mode, in accordance with the transition instruction (step S21, step S37, step S185). The printer 1 contributes to the automatic transition to the template print mode, in response to receiving the transition instruction.

The maintenance server 5 in the above-described embodiment includes the memory 54, the communication part 55 which is configured to be accessed by the printer 1 using the maintenance address, and the CPU 51. The CPU 51 is configured to be capable of performing the address storing process, the related information receiving process, and the management address transmitting process. The address storing process is the process of causing the memory 54 to store the management address and the printer-related information related to the printer 1, in association with each other. The management address is the address of the management server 4, which is the server same as or different from the maintenance server 5. The management address indicates the source from which the print content data for printing a predetermined print content based on a predetermined layout is obtainable. The related information receiving process is the process of receiving, via the communication part 55, the printer-related information from the printer 1 which has accessed the maintenance server 5 using the maintenance address (step S65). The management address transmitting process is the process of transmitting the predetermined management address to the printer 1, in response to receiving the printer-related information (step S72, step S73). The predetermined management address is the address corresponding to the printer-related information among the plurality of management addresses stored in the memory 54.

The address storing process and the management address transmitting process of the maintenance server 5 contribute to causing the administrator of the plurality of printers 1 to register the management addresses each corresponding to one of the plurality of printers 1, collectively, in the maintenance server 5. The maintenance server 5 contributes to saving the time and effort of the user of the plurality of printers 1 in setting the management address necessary to access the management server 4, individually in each of the plurality of printers 1.

In the address storing process, the CPU 51 in the above-described embodiment causes the memory 54 to store the management address including the URL of the management server 4, and the template ID (step S62). The template ID is the data for identifying the template data corresponding to the printer 1. The address storing process of the maintenance server 5 contributes to realizing the management address with a simple configuration including the URL of the management server 4 and the template ID.

The CPU 51 in the first modification causes the memory 54 to store the management address including the URL indicating the storage location, in the management server 4, in which the template data is stored, in the address storing process (step S62). The address storing process of the maintenance server 5 contributes to realizing the management address with a simple configuration including the storage location, in the management server 4, in which the template data is stored.

The CPU 51 in the above-described embodiment causes the memory 54 to store the management address in the address storing process (step S62). The management address indicates the source from which the print content data list is obtainable. The print content data list includes the print content data indicating the print content, and the identification information. The identification information is information for identifying the print content data. The address storing process of the maintenance server 5 contributes to transmitting, to the printer 1, the template data and the print content data list corresponding to the printer 1, more easily than the known technique.

In the address storing process, the CPU 51 in the above-described embodiment causes the memory 54 to store the management address including the URL of the management server 4, the template ID, and the list ID (step S62). The template ID is the data for identifying the template data corresponding to the printer 1. The list ID is the data for identifying the print content data list. The address storing process of the maintenance server 5 contributes to realizing the management address with a simple configuration including the URL of the management server 4, the template ID, and the list ID.

The CPU 51 in the first modification causes the memory 54 to store the management address including the URL, in the address storing process (step S62). The URL indicates the storage location, in the management server 4, in which the template data and the print content data list are stored. The address storing process of the maintenance server 5 contributes to realizing the management address with a simple configuration including the URL of the management server 4.

The printer-related information in the third modification is the segment ID for identifying the segment to which the printer 1 belongs. The CPU 51 causes the memory 54 to store the segment ID and the management address, in association with each other, in the address storing process (step S62). The CPU 51 is configured to be capable of performing the server receiving process of receiving the segment ID from the printer 1 (step S69). The CPU 51 transmits the predetermined management address, from among the plurality of management addresses stored in the memory 54, in the management address transmitting process (step S72, step S73). The predetermined management address is the management address associated with the segment ID transmitted from printer 1.

The address storing process of the maintenance server 5 in the third modification contributes to causing the administrator of the plurality of printers 1 to register the management addresses each corresponding to one of the plurality of printers 1 with the maintenance server 5. The maintenance server 5 contributes to saving the time and effort of the administrator of the plurality of printers 1 in setting the management address necessary to obtain the template data corresponding to the segment, individually in each of the plurality of printers 1.

The CPU 51 in the above-described embodiment is configured to be capable of performing further the substitute information storing process and the substitute information transmitting process. The substitute information storing process is the process in which the CPU 51 causes the memory 54 to store the first printer ID for identifying the printer 1, and the substitute information, in association with each other (step S62). The substitute information indicates that the printer 1 is a substitute printer to be used as a substitute for another printer 1. The substitute information transmitting process is the process in which the CPU 51 transmits the substitute information to the printer 1, in response to the printer 1 accessing the maintenance server 5 (step S73).

The substitute information storing process of the maintenance server 5 in the above-described embodiment contributes to causing the administrator of the plurality of printers 1 to register the substitute information corresponding to each of the plurality of printers 1, collectively with the maintenance server 5. The substitute information transmitting process of the maintenance server 5 contributes to setting the template for saving the time and effort of setting up substitute information in each of the plurality of printers 1.

The CPU 51 in the second modification causes the memory 54 to store the management address corresponding to a case where printer 1 is a substitute printer, in the address storing process (step S62). The substitute information storing process of the maintenance server 5 contributes to switching the different URLs to be used between the case where printer 1 is a substitute printer and a case where the printer 1 is not a substitute printer.

The CPU 51 in the second modification transmits the mutually different management addresses to the printer 1, in the management address transmitting process, between the case where the printer 1 is a substitute printer and the case where the printer 1 is not a substitute printer (step S72, step S73). The management address transmitting process of the maintenance server 5 contributes to switching the different URLs to be used between the case where printer 1 is a substitute printer and a case where the printer 1 is not a substitute printer.

The printer-related information in the above-described embodiment is the first printer ID for identifying the printer 1. In the address storing process (step S62), the CPU 51 causes the memory 54 to store the management address, in association with the first printer ID, in response to the CPU 51 receiving the registration request from another printer 1 different from the printer 1. The registration request requests that the another printer 1 be registered with the maintenance server 5. The registration request includes the first printer ID. The address storing process of the maintenance server 5 contributes to causing the memory 54 to store the management address and the first printer ID.

The CPU 51 in the above-described embodiment is configured to be capable of performing the first error transmitting process. The first error transmitting process is the process of transmitting the first kind error data to the printer 1 in a predetermined case (step S74). The predetermined case is a case where the first printer ID of the printer 1 which has accessed the maintenance server 5 using the maintenance address is not stored in the memory 54. The first kind error data indicates that the first printer ID is not stored in the memory 54. The first error transmitting process of the maintenance server 5 contributes to notifying the printer 1 that the first printer ID of the printer 1 is not stored in the memory 54.

The CPU 51 in the above-described embodiment is configured to be capable of performing the second error transmitting process. The second error transmitting process is the process of transmitting second kind error data different from the first kind error data to the printer 1 in a predetermined case (step S68). The predetermined case is a case where the first printer ID of the printer 1 which has accessed the maintenance server 5 using the maintenance address is stored in the memory 54, but the management address corresponding to the printer 1 cannot be transmitted to the printer 1. The second error transmitting process of the maintenance server 5 contributes to transmitting different error data to the printer 1, depending on the content of the error.

The management server 4 in the above-described embodiment has the memory 44, the communication part 45 which is configured to be accessed by the printer 1 using the management address, and the CPU 41. The CPU 41 of the management server 4 is configured to be capable of performing the template storing process and the template transmitting process. The template storing process is the process of causing the memory 44 to store the template data corresponding to the printer 1, for each of the management addresses (step S82). The template transmitting process is the process of transmitting the predetermined template data to the printer 1 via the communication part 45, in response to the printer 1 accessing the management server 4 using the management address (step S159, step S107, step S109, step S113). The predetermined template data is the data corresponding to the printer 1 among the multiple template data stored in the memory 44. The template transmitting process of the management server 4 contributes to facilitating the process of transmitting, to the predetermined printer 1, the template data corresponding to the predetermined printer 1 as compared with the known technique. The predetermined printer 1 is the printer which has accessed the management server 4 using the management address.

The printer, the maintenance server, the printer control program, and the printer system according to the present disclosure are not limited to the embodiment and modifications described above, and various changes may be made to an extent that the changes do not depart from the gist of the present disclosure. For example, the following modifications may be added as appropriate. The present disclosure can be realized in various forms. The present disclosure may be realized, for example, in the form of a method of controlling a printer, and a non-transitory computer-readable medium storing a printer control program. The present disclosure may be realized, for example, in the form of a method of controlling a maintenance server, a maintenance server program, a management server, a method of controlling a management server, and a non-transitory medium storing a management server program.

(Modification A) The configuration and number of the system 7, the printer 1, the management server 4, and the maintenance server 5 may be changed as appropriate. The maintenance server 5 may be a server which is the same as the management server 4. The system 7 may include a terminal device 8 which controls the printer 1. The terminal device 8 may be, for example, a PC, a smartphone, etc. The kind and number of the printer 1 included in the system 7 may be changed as appropriate.

The display 24 and the input part 23 of the printer 1 may be omitted. The display 24 may be capable of displaying an image. The display 24 may be, for example, an organic EL display, a plasma display, a plasma tube array display, an electronic paper display using electrophoresis or the like. The input part 23 may be an input interface such as a keyboard, a mouse, and a joystick, other than the touch screen. The print head 26 may be changed in accordance with the kind of the printer 1. For example, in a case where the printer 1 is an ink-jet printer, the print head 26 may be a print head which ejects various kinds of ink.

The unit of management for managing the managed printer and the substitute printer in association, may be the owner, the administrator, or the user of the printer 1. The unit of management may be a company, a department, a district, the printer 1, etc., and may not be the store. The substitute printer may be a printer temporarily loaned by the manufacturer or distributor of the printer 1 in a case where the managed printer is out of service. The substitute printer may be operated as a normally-used printer 1 in a case where the managed printer is operating normally.

The management address may indicate the source from which the template data is obtainable. The management address may be, for example, the IP address and the MAC address of the management server 4. The management address may be the IP address and the MAC address of the storage location, in the management server 4, in which the template data is stored.

(Modification B) The program including the instruction for causing the CPU 11 to transmit the status data of FIG. 4 may be stored in the memory 14 by the time the CPU 11 performs the program. The program including the instruction for performing the printer process of FIGS. 5A and 5B and the print controlling process of FIG. 11 may be stored in the memory 14 by the time the CPU 11 performs the program. Therefore, each of the method of obtaining the program, the route of obtaining the program, and the device storing the program may be changed as appropriate.

A program including the instruction for causing the CPU 11 to perform the management server process illustrated in 14 may be stored in the memory 44 by the time the CPU 41 performs the program. Therefore, each of the method of obtaining the program, the route of obtaining the program, and the devices storing the program may be changed as appropriate.

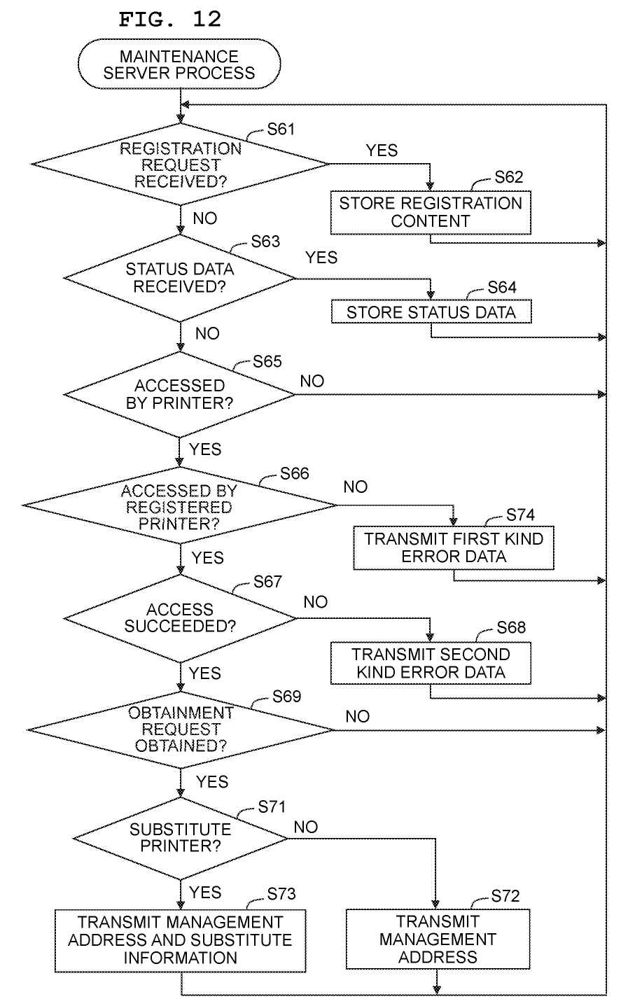

A program including the instruction for causing the CPU 51 to perform the maintenance server process illustrated in FIG. 12 may be stored in the memory 54 by the time the CPU 51 performs the program. Accordingly, each of the method of obtaining the program, the route of obtaining the program, and the device storing the program may be changed as appropriate. The program performed by each of the printer 1, the management server 4, and the maintenance server 5 may be received from another device via a cable or wireless communication and may be stored in a memory device. The another device includes, for example, a PC and a server connected via a network.

(Modification C) Each of the steps of the printer process illustrated in FIGS. 5A and 5B and the print controlling process illustrated in FIG. 11 is not limited to the example performed by the CPU 11. Each of the steps of the management server process illustrated in FIGS. 14A and 14B is not limited to the example performed by the CPU 41. The maintenance server process illustrated in FIG. 12 is not limited to the example performed by the CPU 51. Each of the steps may be performed, in part or in whole, by another electronic device such as ASIC. Each of the steps may be distributed among a plurality of electronic devices such as a plurality of CPUs to be processed. Each of the steps may be reordered, may be omitted, and may be added as necessary.

The following changes may be made to the printer process in FIGS. 5A and 5B and the print controlling process in FIG. 11, as appropriate. The number of the template data associated with the printer ID of one managed printer may be plural. The number of the print content data list associated with one template data may be plural. The number of the print content data associated with the printer ID of one identification information in the print content data list may be plural.

The layout indicated by the template data may be changed as appropriate. The printer 1 may be capable of editing the template data. The kind and number of the print content indicated by the print image may be changed as appropriate. For example, the print image may include date and time-print content including date and time. In this case, the CPU 11 obtains the print instruction including the date and time, in addition to the template ID, in step S39 via the input part 23 or the communication part 21. The CPU 11 may set the date and time-print content to a value specified in the print instruction and perform printing (step S52, step S187). The current date and time may be set in the date and time-print content.

The CPU 11 may be configured not to receive the print content data-related information from the management server 4 via the communication part 21. The CPU 11 may be configured to receive the print content data, via the communication part 21, from another printer 1 which is different from the printer 1 performing the process, or the terminal device 8. The print content data may be data indicating print content input by the administrator or user via the input part 23.

The CPU 11 may be configured not to receive the substitute information from the maintenance server 5 via the communication part 21 in step S8. In this case, the maintenance server 5 may be configured not to store the substitute information. The CPU 11 may be configured to receive the substitute information via the communication part 21 from another printer 1 different from the printer 1 which performs the process or the terminal device 8. The substitute information may be information input by the administrator or user via the input part 23. The substitute information may be the segment ID. In this modification, in a case where a printer 1, which has accessed the management server 4 with the segment ID and which is currently being suspended from the management due to, for example, malfunction, etc., exists among the printers 1 associated with the segment ID, the CPU 41 of the management server 4 may be configured to determine that another printer 1 accessing the management server 4 is the substitute printer. The CPU 11 may be configured not to transmit the substitute information to the management server 4 in step S181.

The CPU 11 may be configured not to receive the print instruction from the management server 4 via the communication part 21. The CPU 11 may be configured not to perform printing based on the print instruction received from the management server 4 via the communication part 21.

The printer 1 may be a printer capable of performing printing using the template data, without changing the print mode. The printer 1 may be a printer dedicated to printing using the template data. In this case, the printer 1 may be unable to perform printing in accordance with the second print instruction.

The CPU 11 may be configured not to receive the substitute information in step S8. The CPU 11 may be configured not to transmit the substitute information to the management server 4 in step S181. The method of setting the next connection address in step S9 and step S43 may be changed appropriately. The next connection address may always be the maintenance address. The CPU 11 may be configured to perform the first receiving process each time the CPU 11 performs the printer process.

The CPU 11 may be configured to omit the process of step S2. The CPU 11 may be configured to accept a setting whether to perform the process of step S2, and perform the process of step S2 in a case where the setting is to perform the process of step S2.

The process of step S5 may be omitted. The message in the process of step S5 may be modified appropriately. After outputting the message in the process of step S5, the CPU 11 may be configured to accept an instruction to print a two-dimensional code indicating the address of the maintenance server 5 which performs the process of registering the printer 1 with the maintenance server 5. The CPU 11 may be configured to accept a setting whether to perform the process of step S5, and may be configured to perform the process of step S5 in a case where the setting is to perform the process of step S5. The CPU 11 may be configured to output a message by voice from a speaker in step S5. In step S5, the CPU 11 may be configured to transmit the message to the terminal device 8 of the owner, administrator, or user of the printer 1. The message may include a part or all of the information necessary to register the printer 1 with the maintenance server 5.

The CPU 11 may be configured not to receive the transition instruction from the management server 4, and may be configured to transition to the template print mode in a case where the CPU 11 receives the template data from the management server 4. The CPU 11 may be configured to receive, from the management server 4, input of an instruction for transitioning to the template print mode, in a case where the CPU 11 receives the template data from the management server 4.

The management server 4 may be configured to omit a process which depends on whether the printing using the template data is possible. For example, the management server 4 may be configured to omit the image data transmitting process of FIG. 20. The status indicated by the status data transmitted in step S56 may be changed as appropriate.

The CPU 11 may be configured not to transmit the printing completion notice, or the printing incompletion notice, to the management server 4 via the communication part 21. The data included in the printing completion notice or the printing incompletion notice may be transmitted as the status data to the management server 4 via the communication part 21. The CPU 11 may be configured to transmit the status data to the maintenance server 5. The CPU 11 may be configured to omit the process performed in the case where the printer 1 is a substitute printer.

The following changes may be made to the maintenance server process of FIG. 12, as appropriate. The maintenance server 5 may be configured to omit the process of each of steps S63 and step S64 and may be configured not to receive the status data from the management server 4. The CPU 51 may be configured not to cause the memory 54 to store the status data received from the management server 4 in step S64, and may be configured to update the state 94 based on the status data.

The CPU 51 of the maintenance server 5 may be configured not to cause the memory 54 to store the substitute information. In a case where the printer 1 which has accessed the maintenance server 5 is a substitute printer (step S71: YES), the CPU 51 may be configured to perform the following process. The CPU 51 of the maintenance server 5 may be configured not to transmit the management address to the substitute printer via the communication part 55, in a case where the managed printer associated with the printer 1 is in operation. The CPU 51 may be configured to transmit singly the management address to the printer 1 via the communication part 55, regardless of whether the printer 1 which has accessed the maintenance server 5 is the substitute printer.

The following changes may be made to the management server process in FIGS. 14A and 14B, as appropriate. The CPU 41 may be configured to omit the processes from step S90 to step S93. The items of the tables 60 and 66 stored in the memory 44, and the format of storage may be changed as appropriate. The table 60 may be configured not to store the number of managed printers or the number of operational printers in association with the segment ID. The CPU 41 may be configured not to register a printer 1, which has newly accessed to the management server 4, with the management server 4, in a case where the number of managed printers is equal to the number of operational printers.

The CPU 41 may be configured to omit the processes from step S94 to step S96, and may be configured not to receive the status data from the printer 1. The CPU 41 may be configured to obtain the status of the printer 1 from the terminal device 8 via the communication part 45.

The CPU 41 may be configured to perform singly the process of S111 or the process of step S112 in the registration requesting process of FIG. 17B. The CPU 41 may be configured to obtain the update instruction on whether to perform which one of the process of step S111 and the process of step S112, based on the registration request. The printer 1 may be configured to perform the process of step S111 and the process of step S112.

The CPU 41 may be configured to perform the process of step S111 in a case where the managed printer indicated by the substitute information is recoverable within a short period (step S110: YES). The CPU 41 may be configured to perform the process of step S112 in a case where the managed printer indicated by the substitute information is not recoverable within a short period (step S110: NO). Similarly to the process of step S111 and the process of step S112, the CPU 41 may be configured to perform singly the process of step S136 or the process of step S135 in the image data transmitting process of FIG. 20.

The CPU 41 may be configured to omit the process of S108 and perform the processes from steps S110 to S112, regardless of whether the printer ID of another printer 1 different from the printer 1 which performs the process is stored in the print content data list L1. In the process of S108, the CPU 41 may be configured to determine whether the printer ID of the managed printer indicated by the substitute information is stored in the print content data list L1. In a case where the printer ID of the managed printer indicated by the substitute information is stored in the print content data list L1, the CPU 41 may be configured to perform the processes from step S110 to step S112. In a case where the printer ID of the managed printer indicated by the substitute information is not stored in the print content data list L1, the CPU 41 may be configured to perform the process of step S109.

What is claimed is:

1. A printer comprising:
a memory configured to store a maintenance address which is an address of a maintenance server;
a printing mechanism;
a communication interface; and
a processor,
wherein the processor is configured to perform:
a first transmitting process of accessing the maintenance server using the maintenance address and of transmitting printer-related information related to the printer to the maintenance server via the communication interface;
a first receiving process of receiving, from the maintenance server via the communication interface and in accordance with the first transmitting process, a management address indicating a source from which template data is obtainable, the template data corresponding to the printer-related information, the template data being usable for printing a predetermined print content based on a predetermined layout;
a second receiving process of accessing a management server using the management address and of receiving the template data corresponding to the printer via the communication interface, the management server being same as or different from the maintenance server;
a print instruction obtaining process of obtaining a first print instruction or a second print instruction, the first print instruction including print content data-related information and a template ID for identifying the template data, the print content data-related information being related to print content data indicating the print content, the second print instruction including image data indicating a print image based on the print content data and the template data; and
a printing process of causing the printing mechanism to perform printing of a print image based on the first print instruction, or the print image indicated by the image data included in the second print instruction, the print image based on the first print instruction being an image in which the print content is applied to the layout indicated by the template data associated with the template ID.

2. The printer according to claim 1, wherein
in the first receiving process, the processor is configured to receive, via the communication interface, the management address including a URL of the management server and the template ID of the template data corresponding to the printer, and
in the second receiving process, the processor is configured to receive, via the communication interface, the template data identified by the URL and the template ID and corresponding to the printer.

3. The printer according to claim 1, wherein
in the first receiving process, the processor is configured to receive, via the communication interface, the management address including a URL indicating a storage location, in the management server, in which the template data is stored, and
in the second receiving process, the processor is configured to access the storage location indicated by the URL and to receive the template data via the communication interface.

4. The printer according to claim 1, wherein
in the first receiving process, the processor is configured to receive, via the communication interface, the management address indicating a source from which the template data and a print content data list are obtainable, the print content data list including print content data indicating the print content and identification information for identifying the print content data,
in the second receiving process, the processor is configured to receive the template data and the print content data list via the communication interface,
the print content data-related information is the identification information, and
in a case where the processor obtains the first print instruction including the template ID and the identification information in the print instruction obtaining process, the processor is configured to cause, in the printing process, the printing mechanism to print the print image in which the print content indicated by the print content data is applied to the layout indicated by the template data.

5. The printer according to claim 1, wherein
the print content data-related information is the print content data, and
in a case where the processor obtains the first print instruction including the template ID and the print content data in the print instruction obtaining process, the processor is configured to cause, in the printing process, the printing mechanism to print the print image in which the print content indicated by the print content data is applied to the layout indicated by the template data.

6. The printer according to claim 1, wherein
the printer-related information is a segment ID for identifying a segment to which the printer belongs,
in the first transmitting process, the processor is configured to transmit the segment ID to the maintenance server via the communication interface, and
in the first receiving process, the processor is configured to receive the management address corresponding to the segment ID, from the maintenance server and via the communication interface.

7. The printer according to claim 1, wherein
the processor is configured to perform:
a substitute information obtaining process of obtaining substitute information indicating that the printer is a substitute printer to be used as a substitute for another printer different from the printer; and
a substitute information transmitting process of transmitting the substitute information to the management server via the communication interface, and
in the second receiving process, the processor is configured to access the management server using the management address and to receive, via the communication interface, the template data corresponding to the another printer indicated by the substitute information.

8. The printer according to claim 7, wherein
in the print instruction obtaining process, the processor is configured to receive, via the communication interface, the first print instruction or the second print instruction from the management server in a case where printing incompletion information indicating an incomplete print job using the template data is present in the another printer, and
in a case where the processor receives the first print instruction or the second print instruction from the management server, the processor is configured to perform the printing process.

9. The printer according to claim 1, wherein
the processor is configured to further perform a setting process of setting a server which is either the maintenance server or the management server, and to which the printer is to connect next,
in a case where the server to which the printer is to connect next is the maintenance server, the processor is configured to perform the second receiving process, after performing the first receiving process, via the communication interface, and
in a case where the server to which the printer is to connect next is the management server, the processor is configured not to perform the first receiving process, and is configured to perform the second receiving process, via the communication interface, using the management address stored in the memory.

10. The printer according to claim 9, wherein
the printer-related information is a first printer ID for identifying the printer,
in a case where the server to which the printer is to connect next is the maintenance server, the processor is configured to perform an output process of outputting the first printer ID, before performing the first transmitting process, and
in a case where the processor accesses the maintenance server using the maintenance address, the first printer ID output in the outputting process being registered with the maintenance server, the processor is configured to receive the management address via the communication interface in the first receiving process.

11. The printer according to claim 1, wherein
in a case where the processor accesses the maintenance server using the maintenance address and the processor receives a first kind error data indicating that the printer is not registered with the maintenance server, the processor is configured to further perform a message outputting process of outputting a message urging registration of the printer with the maintenance server, and
the processor is configured to perform the first transmitting process again, after performing the message outputting process.

12. The printer according to claim 11, wherein in a case where the processor accesses the maintenance server using the maintenance address and the processor receives a second kind error data which is different from the first kind error data, the processor is configured to perform the first transmitting process again, without outputting a message notifying of occurrence of an error.

13. The printer according to claim 1, wherein the processor is configured to further perform:
a mode transition instruction receiving process of receiving, from the management server via the communication interface, a transition instruction for transitioning to a template print mode in which printing is performed using the template data stored in the memory; and
a mode transitioning process of transitioning to the template print mode in accordance with the transition instruction.

14. A maintenance server comprising:
a maintenance server memory;
a maintenance server communication interface configured such that a printer accesses the maintenance server communication interface using a maintenance address; and
a maintenance server processor;
wherein the maintenance server processor is configured to perform:
an address storing process of storing a management address indicating a source from which template data is obtainable, and printer-related information related to the printer, in the maintenance server memory, while associating the management address and the printer-related information with each other, the management address being an address of a management server which is a server same as or different from the maintenance server, the template data being usable for printing a predetermined print content based on a predetermined layout;
a related information receiving process of receiving, via the maintenance server communication interface, the printer-related information from the printer which has accessed the maintenance server using the maintenance address; and
a management address transmitting process of transmitting the management address, which corresponds to the printer-related information and is stored in the maintenance server memory, to the printer via the maintenance server communication interface, in response to the maintenance server processor receiving the printer-related information.

15. The maintenance server according to claim 14, wherein in the address storing process, the maintenance server processor is configured to store, in the maintenance server memory, the management address including a URL indicating a storage location, in the management server, in which the template data is stored.

16. The maintenance server according to claim 14, wherein in the address storing process, the maintenance server processor is configured to store, in the maintenance server memory, the management address indicating a source from which a print content data list is obtainable, the print content data list including print content data indicating the print content and identification information for identifying the print content data.

17. The maintenance server according to claim 14, wherein
the printer-related information is a segment ID for identifying a segment to which the printer belongs,
in the address storing process, the maintenance server processor is configured to store the segment ID in the maintenance server memory, while associating the segment ID with the management address,
the maintenance server processor is configured to further perform a server receiving process of receiving the segment ID from the printer via the maintenance server communication interface, and
in the management address transmitting process, the maintenance server processor is configured to transmit, via the maintenance server communication interface, the management address stored in the maintenance server memory and corresponding to the segment ID transmitted from the printer.

18. The maintenance server according to claim 14, wherein the maintenance server processor is configured to perform:
a substitute information storing process of storing, in the maintenance server memory, a first printer ID for identifying the printer and substitute information indicating that the printer is a substitute printer to be used as a substitute for another printer; and
a substitute information transmitting process of transmitting the substitute information to the printer via the maintenance server communication interface, in response to the printer accessing the maintenance server.

19. The maintenance server according to claim 18, wherein the management address corresponding to a case where the printer is the substitute printer and the management address corresponding to a case where the printer is not the substitute printer are mutually different.

20. A printer system comprising: a printer; a maintenance server; and a management server,
wherein the printer includes: a memory configured to store a maintenance address which is an address of the maintenance server; a printing mechanism; a communication interface; and a processor,
the processor is configured to perform:
a first transmitting process of accessing the maintenance server using the maintenance address and of transmitting, via the communication interface, printer-related information related to the printer to the maintenance server;
a first receiving process of receiving, from the maintenance server via the communication interface and in accordance with the first transmitting process, a management address indicating a source from which template data is obtainable, the template data corresponding to the printer-related information and being usable for printing a predetermined print content based on a predetermined layout;
a second receiving process of accessing a management server using the management address, the management server being same as or different from the maintenance server, and of receiving the template data corresponding to the printer via the communication interface;
a print instruction obtaining process of obtaining a first print instruction or a second print instruction, the first print instruction including print content data-related information and a template ID for identifying the template data, the print content data-related information being related to print content data indicating the print content, the second print instruction including image data indicating a print image based on the print content data and the template data; and
a printing process of causing the printing mechanism to perform printing of a print image based on the first print instruction, or the print image indicated by the image data included in the second print instruction, the print image based on the first print instruction being an image in which the print content is applied to the layout indicated by the template data associated with the template ID,
the maintenance server includes: a maintenance server memory; a maintenance server communication interface configured such that the printer accesses the maintenance server using the maintenance address; and a maintenance server processor,
the maintenance server processor is configured to perform:
an address storing process of storing the management address and the printer-related information related to the printer in the maintenance server memory, while associating the management address with the printer-related information, the management address being an address of the management server and indicating a source from which the template data is obtainable;
a related information receiving process of receiving, via the maintenance server communication interface, the printer-related information from the printer which has accessed the maintenance server using the maintenance address; and
a management address transmitting process of transmitting the management address corresponding to the printer-related information and stored in the maintenance server memory, to the printer via the maintenance server communication interface, in response to the maintenance server processor receiving the printer-related information,
the management server includes: a management server memory; a management server communication interface configured such that the printer accesses the management server using the management address; and a management server processor, and
the management server processor is configured to perform:
a template storing process of storing the template data corresponding to the printer for the management address, in the management server memory; and
a template transmitting process of transmitting the template data corresponding to the printer and stored in the management server memory, to the printer via the management communication interface, in response to the printer accessing the management server using the management address.
